(19) United States
(12) Patent Application Publication
(10) Pub. No.: US 2016/0267018 A1
(43) Pub. Date: Sep. 15, 2016

(54) PROCESSING DEVICE AND CONTROL METHOD FOR PROCESSING DEVICE

(71) Applicant: FUJITSU LIMITED, Kawasaki-shi (JP)

(72) Inventors: Takashi Shimizu, Kawasaki (JP); TAKASHI MIYOSHI, Ohta (JP)

(73) Assignee: FUJITSU LIMITED, Kawasaki-shi (JP)

(21) Appl. No.: 15/061,362

(22) Filed: Mar. 4, 2016

(30) Foreign Application Priority Data
Mar. 13, 2015 (JP) 2015-050729

(51) Int. Cl. G06F 12/12; G06F 12/08

(52) U.S. Cl. CPC G06F 12/12; G06F 12/0815; G06F 2212/69; G06F 2212/621; G06F 2212/1021

(57) ABSTRACT

A processing device includes a processing unit that executes a memory access instruction, a cache memory, and a cache control unit. The cache control unit includes a cache hit determining unit that determines a cache hit or not, based on the memory access instruction, a read counting unit that increments a count value of read instructions, a write counting unit that increments a count value of write instructions, a replacement criteria generating unit that, based on the count value of read instructions and the count value of write instructions, generates a target read area capacity and a target write area capacity which minimize an average memory access time needed to access the main memory device, and a replacement control unit that controls replacement of an area in the cache memory, based on the target read area capacity and the target write area capacity.

### CROSS-REFERENCE TO RELATED APPLICATION

This application is based upon and claims the benefit of priority of the prior Japanese Patent Application No. 2015-050729, filed on Mar. 13, 2015, the entire contents of which are incorporated herein by reference.

### FIELD

The present invention relates to a processing device and a control method for a processing device.

### BACKGROUND

A processing device (or an arithmetic processing device) is a processor or a central processing unit (CPU). The processing device includes a single CPU core or a plurality of CPU cores, a cache, and a memory access control circuit and is connected to a main storage device (main memory). The cache includes a cache controller and a cache memory. In response to a memory access instruction issued by the CPU core, the cache controller accesses the cache memory when a determination of a cache hit is made and accesses the main memory when a determination of a cache miss is made. In case of a cache miss, the cache controller registers data in the accessed main memory to the cache memory.

While a memory access instruction is completed in a short period of time in the case of a cache hit since the cache memory is accessed, a memory access instruction needs a long period of time in the case of a cache miss since the main memory is accessed. Therefore, proposals for reducing processing time of a memory access instruction by efficiently arranging and using areas in a cache memory have been made. Examples of such proposals are disclosed in Japanese National Publication of International Patent Application No. 2013-505488 and Japanese Laid-open Patent Publication No. 2000-155747.

Generally, a dynamic random access memory (DRAM) is used as a main memory. A DRAM is suitable for a main memory due to its large capacity and short read and write times.

Meanwhile, there is a recent trend of replacing DRAMs with solid state devices (SSDs, flash memories) or hard disk drives (HDDs) which have lower per-bit costs than DRAMs. Furthermore, Storage Class Memories (SCMs) with per-bit costs and access times between those of DRAMs and SSDs are being developed.

### SUMMARY

However, while the time needed by a read and the time needed by a write (hereinafter, sometimes referred to as a read time, a write time, or a latency) in the case of a DRAM are approximately the same, the time needed by a write is approximately 10 times longer than the time needed by a read in the case of a flash memory of an SSD. In addition, the time needed by a write is similarly estimated to be longer than the time needed by a read for many SCMs.

For this reason, when a cache line registered in the cache memory by a write instruction is released by a cache miss of a read instruction and replaced by a cache line of the read instruction, a subsequent write instruction to the same address results in a cache miss and causes a memory access to the main memory. As a result, a write instruction to the main memory needing a long processing time is executed and causes an increase in overall memory access time and a decline in performance of a system.

According to an aspect of the embodiments, a processing device capable of accessing a main memory device, includes:

a processing unit that executes a memory access instruction;

a cache memory that retains a part of data stored by the main memory device; and

a cache control unit that controls the cache memory in response to the memory access instruction, wherein

the cache control unit includes:

a cache hit determining unit that determines a cache hit or a cache miss at the cache memory unit, based on a memory access instruction executed by the processing unit;

a read counting unit that, when the memory access instruction executed by the processing unit is a read instruction, increments a count value of read instructions;

a write counting unit that, when the memory access instruction executed by the processing unit is a write instruction, increments a count value of write instructions;

a replacement criteria generating unit that, based on the count value of read instructions counted by the read counting unit and the count value of write instructions counted by the write counting unit, generates a target read area capacity and a target write area capacity which minimize an average memory access time needed to access the main memory device in response to a cache miss determined by the cache miss determining unit; and

a replacement control unit that controls replacement of an area in the cache memory, based on the target read area capacity and the target write area capacity, when the cache miss occurs.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a processing device (a CPU chip) according to the present embodiment;

FIG. 2 is a diagram illustrating a configuration example of the L2 cache in the CPU chip according to the present embodiment;

FIG. 3 is a diagram illustrating a configuration example of cache lines of a cache memory according to the present embodiment;

FIG. 4 is a diagram illustrating a configuration example of a cache control circuit of a cache control unit;

FIG. 5 is a diagram illustrating a configuration example of the replacement criteria generation circuit 34 in the cache control unit 32;

FIG. 6 is a diagram explaining the generation of a cache miss probability by the cache miss probability generation circuit 347;

FIG. 7 is a diagram illustrating a configuration of a cache tag memory in a cache memory according to the first embodiment;

FIG. 8 is a flow chart illustrating cache control by the cache control unit 32 according to the first embodiment;

FIG. 9 is a flow chart of a cache line replacement process according to the first embodiment;

FIG. 10 is a diagram explaining a corrected access frequency and weight values according to the second embodiment;

FIG. 11 is a diagram illustrating a configuration of a cache tag memory in a cache memory according to the second embodiment;

FIG. 12 is a flow chart illustrating cache control by the cache control unit 32 according to the second embodiment;

FIG. 13 is a flow chart of a cache line replacement process according to the second embodiment;

FIG. 14 is a diagram illustrating an example of an optimal weight value lookup table according to the second embodiment;

FIG. 15 is a diagram illustrating a configuration of a cache tag memory in a cache memory according to the third embodiment;

FIG. 16 is a flow chart illustrating cache control by the cache control unit 32 according to the third embodiment;

FIG. 17 is a flow chart of a cache line replacement process according to the third embodiment;

FIG. 18 is a state transition diagram from power-on of an information processing apparatus including a CPU (processing device) to execution of an application;

FIG. 19 is a timing chart illustrating an operation when a cache miss occurs as a result of a read instruction to address A;

FIG. 20 is a timing chart illustrating an operation when a cache hit occurs as a result of a read instruction to address A;

FIG. 21 is a timing chart illustrating an operation when a cache miss occurs as a result of a write instruction to address A;

FIG. 22 is a timing chart illustrating an operation when a cache hit occurs as a result of a write instruction to address A;

FIG. 23 is a timing chart illustrating an update process of the working set area capacity M;

FIG. 24 is a diagram illustrating an update process of a weight value;

FIG. 25 is a timing chart illustrating a process of flushing a clean cache line upon a cache miss; and

FIG. 26 is a timing chart illustrating a process of flushing a dirty cache line upon a cache miss.

### DESCRIPTION OF EMBODIMENTS

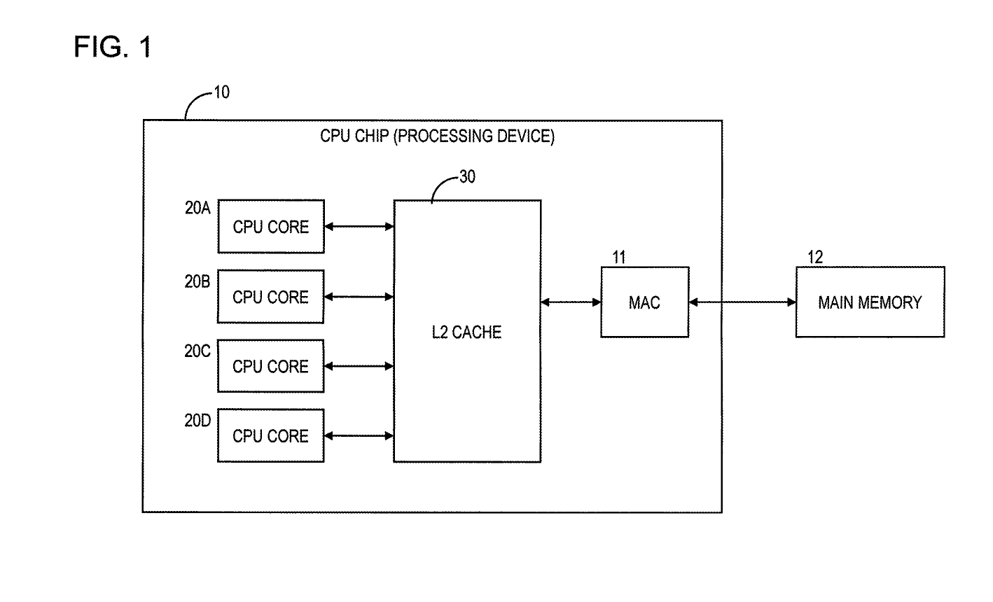

FIG. 1 is a diagram illustrating a configuration example of a processing device (a CPU chip) according to the present embodiment. A CPU chip 10 illustrated in FIG. 1 includes four CPU cores 20A to 20D, an L2 cache 30, and a memory access controller 11. The CPU chip 10 is connected to an external main memory (main storage device) 12 via a memory access controller 11.

The main memory 12 is, for example, a flash memory or an SCM such as a resistive random-access memory (ReRAM) or a ferroelectric RAM (FeRAM). With the main memory 12, the time needed by a write (write latency) is longer than the time needed by a read (read latency).

The CPU core 20 executes an application program and executes a memory access instruction. The CPU core 20 includes an L1 cache and, when a cache line of an address of a memory access instruction does not exist in the L1 cache, the memory access instruction is input to a pipeline of a cache controller of the L2 cache 30.

In response to the memory access instruction, the L2 cache 30 determines whether or not a cache hit has occurred, and accesses a cache line in the cache memory in the L2 cache 30 in the case of a cache hit. On the other hand, in the case of a cache miss, the L2 cache 30 accesses the main memory 12 via the memory access controller 11.

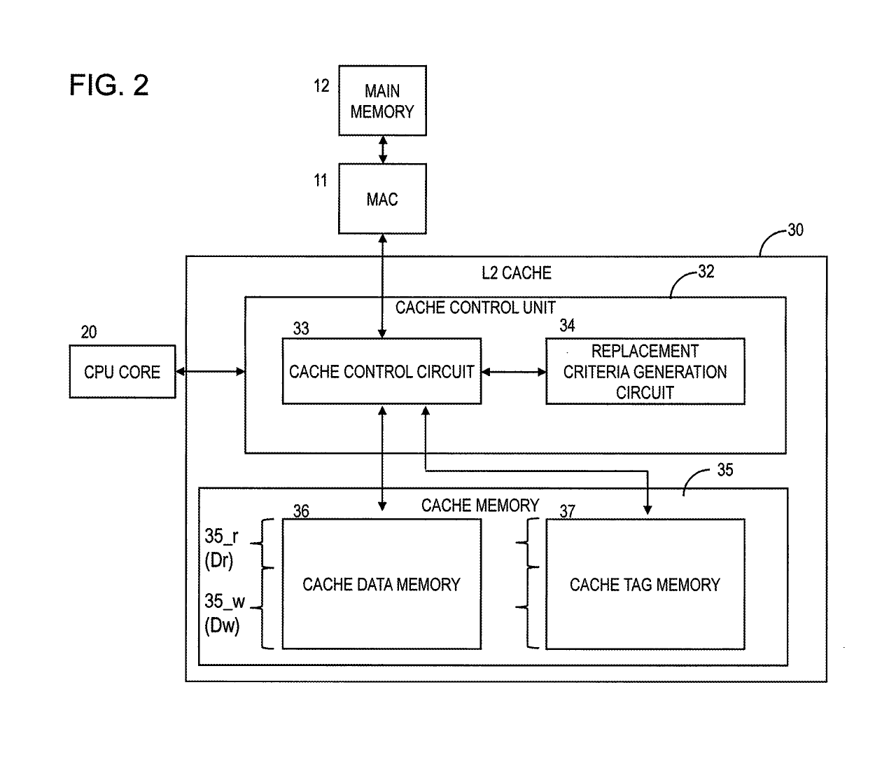

FIG. 2 is a diagram illustrating a configuration example of the L2 cache in the CPU chip according to the present embodiment. The L2 cache (hereinafter, simply “cache”) 30 includes a cache control unit 32 responsible for cache control and a cache memory 35. A cache control circuit 33 in the cache control unit 32 performs a cache hit determination in response to input of a memory access instruction, and performs access control to the cache memory 35 in the case of a cache hit and performs access control to the main memory 12 via the memory access controller 11 in the case of a cache miss. In addition, in the case of a cache miss, the cache control circuit 33 releases any of the cache lines in the cache memory 35 and registers data and the like in the main memory to a new cache line. The replacing of cache lines is referred to as a cache line replacement process.

A replacement criteria generation circuit 34 in the cache control unit 32 generates determination criteria of a cache line to be released in a cache line replacement process. The determination criteria will be described in detail later.

The cache memory 35 includes a cache data memory 36 for storing data and a cache tag memory 37 for storing tag information. The cache data memory 36 includes a plurality of cache lines each having a capacity of a cache registration unit. The cache tag memory 37 stores address information, status information, and the like of each cache line. In addition, the cache data memory 36 stores data being subject to a memory access in each cache line.

In the present embodiment, the cache memory 35 is divided into a read area 35_r including a plurality of cache lines corresponding to an address of a read instruction and a write area 35_w including a plurality of cache lines corresponding to an address of a write instruction. In this case, the read area 35_r is an area including cache lines often referenced by read instructions (for example, read instructions constitute 50% or more of access instructions) and the write area 35_w is an area including cache lines often referenced by write instructions (for example, write instructions constitute 50% or more of access instructions). In other words, cache lines include cache lines mainly referenced by read instructions and cache lines mainly referenced by write instructions. However, a cache line in the read area is referenced not only by a read instruction and, similarly, a cache line in the write area is referenced not only by a write instruction.

Moreover, the 50% criteria described above may be modified so that an area is considered as a read area when read instructions constitute 60% or more of access instructions and an area is considered as a write area when write instructions constitute 40% or more of access instructions. This is because, generally, many access instructions are read instructions. Alternatively, a read area and a write area may be determined by setting appropriate criteria %.

In the present embodiment, when a process in a program is being executed by a CPU core, the number of read instructions and the number of write instructions among memory access instructions are monitored by a counter or the like to calculate or generate a capacity Dr of a target read area and a capacity Dw of a target write area that are optimal with respect to the process being executed. For example, an optimal target value is a target read area capacity and a target write area capacity which, based on the numbers of read instructions and write instructions, minimize an average memory access time of accesses to the main memory 12 in response to a cache miss. In addition, when a cache miss occurs, the cache control unit 32 performs cache line replacement control so that the read area 35_r and the write area 35_w in the cache memory 35 approach the target read area capacity Dr and the target write area capacity Dw. Replacement control will be described in detail later.

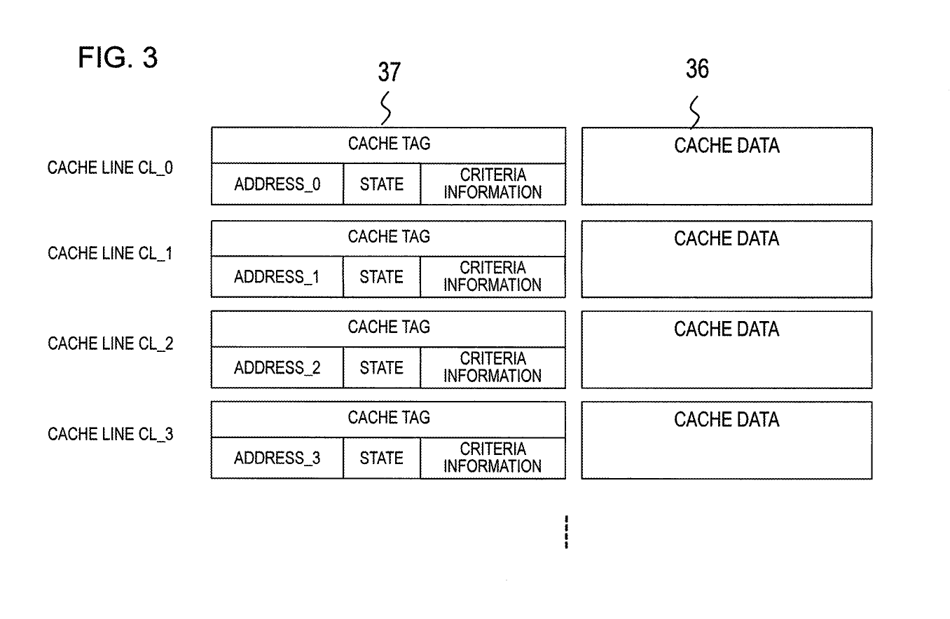

FIG. 3 is a diagram illustrating a configuration example of cache lines of a cache memory according to the present embodiment. FIG. 3 illustrates four cache lines CL_0 to CL_3. The cache tag memory 37 of each cache line stores address information ADDRESS, status information STATE of data such as E, S, M, and I, and criteria information representing criteria of cache line replacement control. The criteria information differs among the respective embodiments to be described later. In addition, the cache data memory 36 of each cache line stores data.

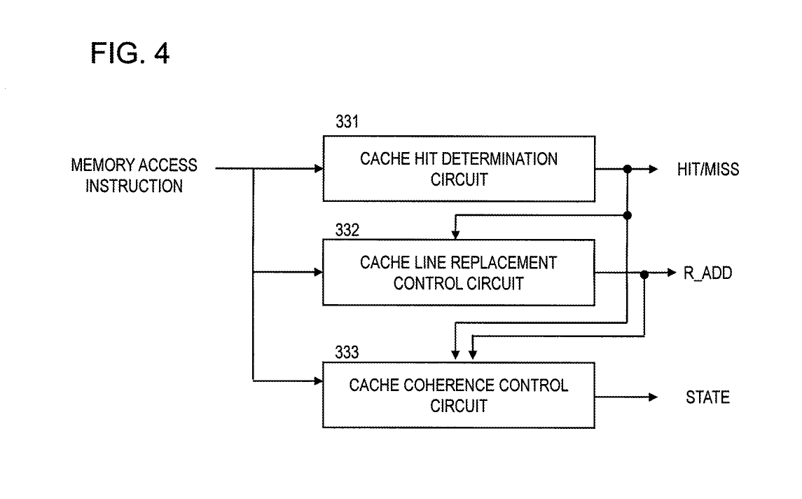

FIG. 4 is a diagram illustrating a configuration example of a cache control circuit of a cache control unit. The cache control circuit 33 includes a cache hit determination circuit 331, a cache line replacement control circuit 332, and a cache coherence control circuit 333.

In response to a memory access instruction, the cache hit determination circuit 331 searches among address information in the cache tag memory 37 and performs a cache hit determination based on whether or not a cache line with an address corresponding to the instruction exists. In addition, when a memory access instruction is issued, the cache hit determination circuit 331 increments a read counter or a write counter to be described later in accordance with the type of the instruction.

The cache line replacement control circuit 332 performs cache line replacement control in response to a cache miss. Although a detailed process will be described later, the cache line replacement control circuit 332 releases a cache line selected based on replacement criteria and registers data in the released cache line as a new cache line.

The cache coherence control circuit 333 updates a status of the data of a cache line and stores the status in the cache tag memory and, further, controls a process of writing back data of the cache line to the main memory in accordance with the status or the like. Examples of a status include an I (Invalid) state where data of a cache line is invalid, an M (Modified) state where data of a cache line only exists in its cache memory and has been changed from data in the main memory, an S (Shared) state where data of a cache line exists in the cache memories of a plurality of L2 caches and has not been changed from data in the main memory, and an E (Exclusive) state where data of a cache line does not exist in other cache memories.

For example, the cache coherence control circuit 333 updates the status from the I state to the E state when new data is registered in a cache, and updates the status from the E state to the M state when the registered data in the cache is changed. In addition, when a cache line of data in the E state or the S state is released, the cache coherence control circuit 333 does not write back the data to the main memory. However, when a cache line of data in the M state is released, the cache coherence control circuit 333 releases the cache line after writing back the data in the main memory.

[Cache Line Replacement Control According to Present Embodiment]

In a cache line replacement process, generally, when a cache miss occurs, a cache line with a lowest reference frequency among cache lines of the cache memory is deleted and data acquired by accessing the main memory is registered in a new cache line. Alternatively, there is another method in which a cache line that has not been referenced for the longest time is selected as a cache line to be deleted. The former is referred to as a least frequently used (LFU) scheme and the latter as a least recently used (LRU) scheme.

In the replacement method described above, when read instructions occur more frequently than write instructions, a cache line referenced by a write instruction is flushed and cache misses occur frequently due to a write instruction. When write time of the main memory is longer than a read time of the main memory, a main memory access due to a cache miss by a write instruction occurs frequently, so that processing efficiency of memory access instructions declines.

Therefore, in the present embodiment, cache line replacement control is performed so that a cache line that is frequently referenced by a write instruction is preferentially retained in the cache over a cache line that is frequently referenced by a read instruction. However, to what degree a cache line associated with a write instruction is prioritized varies depending on (1) a read probability Er and a write probability Ew of a process being processed by a CPU core, (2) a size M of a user area (a capacity of a working set area) in the main memory, (3) a read latency Tr and a write latency Tw of the main memory, and the like.

In consideration thereof, in the present embodiment, among the variation factors described above, (1) and (2) are to be monitored while (3) is to be acquired from a main memory device upon power-on or the like. In addition, an average access time to the main memory that is a penalty incurred upon the occurrence of a cache miss is calculated using these variation factors and a target read area capacity Dr and a target write area capacity Dw which minimize the average access time to the main memory are generated. Furthermore, the cache line replacement control circuit of the cache control unit selects a cache line to be flushed from the cache memory (a replacement target cache line) in the replacement process so that the cache memory is going to have the target read area capacity Dr and the target write area capacity Dw.

An average value P of access times by memory access instructions can be obtained by the following expression.

P=Er*(Tr*Hr+TCr*(1−Hr))+Ew*(Tw*Hw+TCw*(1−Hw)) (1)

In expression (1), Er, Ew, Tr, Tw, Hr, Hw, TCr, and TCw respectively denote the following.
Er: probability of occurrence of read instructions among memory access instructions
Ew: probability of occurrence of write instructions among memory access instructions
Tr: time needed by a read from main memory or read latency
Tw: time needed by a write to main memory or write latency
Hr: cache miss probability of read instruction, (1−Hr) represents cache hit probability
Hw: cache miss probability of write instruction, (1−Hw) represents cache hit probability
TCr: time needed to complete transfer of cache data to CPU core when read instruction results in a hit
TCw: time needed to complete overwrite of cache data when write instruction results in a hit

In the expression provided above, a first term represents an average value of access times of reads and a second term represents an average value of access times of writes. In the first term, Tr*Hr*Er is a product of read latency Tr, read cache miss probability Hr, and read occurrence probability Er, and TCr*(1−Hr)*Er is a product of read time TCr of the cache memory, read cache hit probability (1−Hr), and read occurrence probability Er. In addition, in the second term, Tw*Hw*Ew is a product of write latency Tw, write cache miss probability Hw, and write occurrence probability Ew, and TCw*(1−Hw)*Ew is a product of write time TCw of the cache memory, write cache hit probability (1−Hw), and write occurrence probability Ew.

Processing times TCr and TCw upon a cache hit are significantly shorter than processing times Tr and Tw upon a cache miss. Therefore, an average value P1 of access times when memory access instructions result in a cache miss is obtained by ignoring the time needed in the case of a cache hit. Simply put, the average memory access time P1 due to a cache miss is obtained by excluding the time in case of a cache hit from expression (1) above.

In other words, the average access time P1 in cases where memory access instructions result in a cache miss is expressed as follows.

P1=Er*(Tr*Hr)+Ew*(Tw*Hw) (2)

The average access time P1 upon a cache miss is a penalty time incurred by a cache miss.

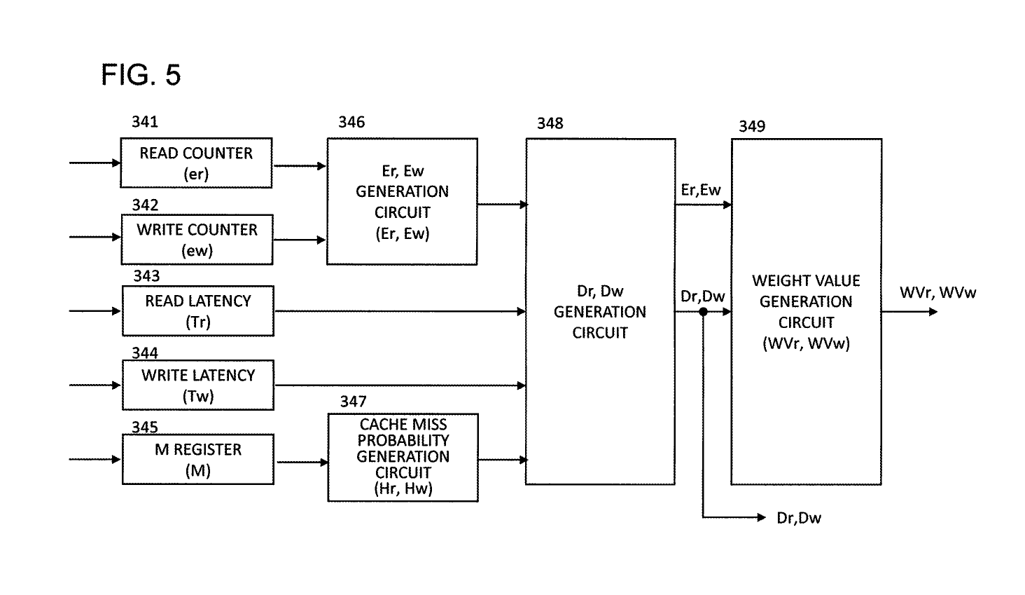

FIG. 5 is a diagram illustrating a configuration example of the replacement criteria generation circuit 34 in the cache control unit 32. A first example of replacement criteria of a cache line in the case of a cache miss is a target read area capacity Dr and a target write area capacity Dw which minimize the average access time P1 in expression (2). In addition, a second example of replacement criteria is a corrected access frequency obtained by correcting access frequency of memory access instructions to the cache memory by a read weight value WVr and a write weight value WVw. A third example is a corrected time difference obtained by correcting a time difference between a latest access time and a cache miss time by a weight value.

The replacement criteria generation circuit 34 illustrated in FIG. 5 includes a read counter (read counting unit) 341 that counts read instructions, a write counter (write counting unit) 342 that counts write instructions, a register 343 that stores a read latency Tr, a register 344 that stores a write latency Tw, and an M register 345 that stores a size M of a memory space (a working set area) accessed by a user in the main memory.

With respect to the read counter and the write counter, when a memory access instruction is issued to the cache control unit, the cache control unit determines a type of the instruction and increments the read counter 341 in the case of read and increments the write counter 342 in the case of write. Both counter values er and ew represent proportions of read and write among memory access instructions in the process being executed.

In addition, as illustrated in FIG. 5, an Er, Ew generation circuit 346 generates a read probability Er and a write probability Ew in the process being executed from the counter values er and ew of the process. Expressions used for the generation are, for example, as follows.

Er=roundup(256*er/(er+ew)) (3)

Ew=roundup(256*ew/(er+ew)) (4)

In other words, the read probability Er and the write probability Ew are integer values obtained by multiplying by 256 to normalize occurrence probabilities er/(er+ew) and ew/(er+ew). In the expressions, roundup denotes a roundup function.

The read counter 341 and the write counter 342 are reset each time the process is changed. In addition, in the case of an overflow, for example, both counters are initialized to 0. Although a ratio between reads and writes becomes inaccurate immediately after initialization, problems can be minimized by performing updates the conversion criteria at an appropriate frequency.

The read latency Tr and the write latency Tw can be acquired from, for example, the main memory when the CPU is powered on. A ratio between Tr and Tw may be acquired as a parameter. The parameter need only linearly varying with respect to Tr and Tw.

The size M of a memory space (working set area) is a size of a set of virtual memory pages being used by a process at a given point and varies depending on the process. The size M of the memory space is stored in a memory access controller MAC (or a memory management unit MMU) in the CPU chip. Therefore, the cache control unit 32 can make a query for the size M based on an ID of the process being executed to the memory access controller MAC. The size M of the memory space is updated when an OS makes a memory request (page fault) or when a context swap (replacement of information of a register) of the CPU occurs. However, the size M of the updated memory space can be acquired by making a query to the memory access controller MAC at a timing of updating conversion criteria.

As illustrated in FIG. 5, a cache miss probability generation circuit 347 generates a cache miss probability Hr for read and a cache miss probability Hw for write based on the memory space size M, a cache line capacity c, the target read area capacity Dr, and the target write area capacity Dw.

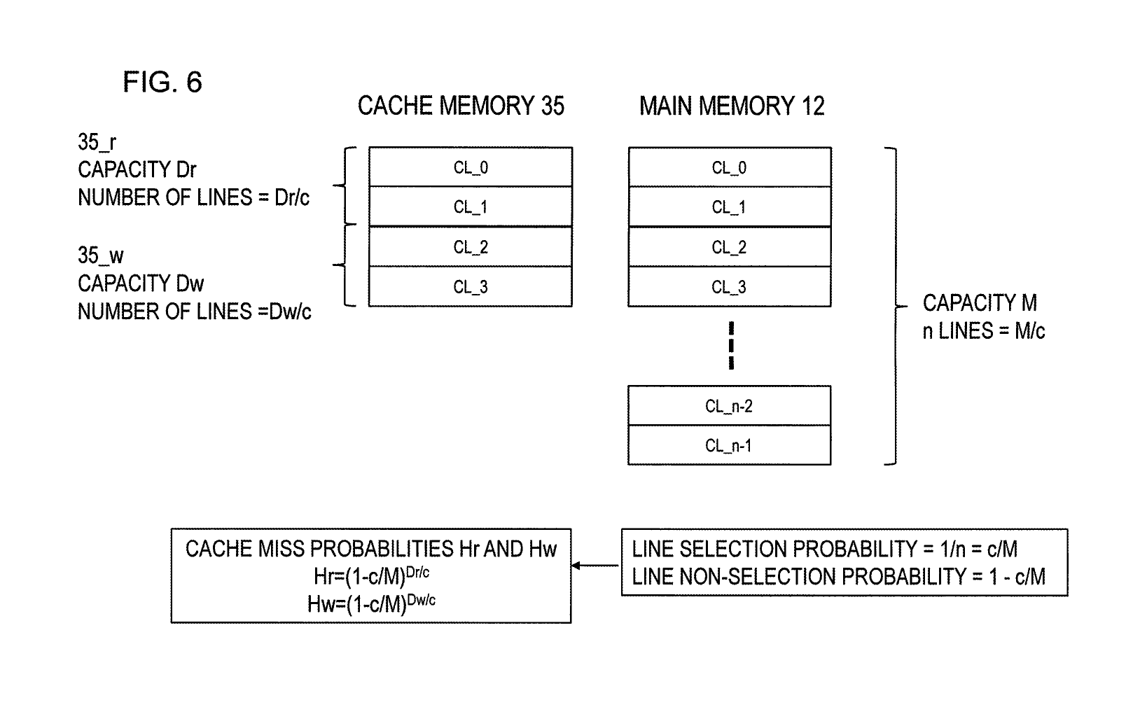

FIG. 6 is a diagram explaining the generation of a cache miss probability by the cache miss probability generation circuit 347. A cache miss probability of the cache memory 35 is obtained by raising a probability at which areas corresponding to cache lines CL_0 to CL_n−1 in the main memory 12 are not selected by an access, to the power of the number of cache lines in the cache memory 35.

In FIG. 6, since M denotes the capacity of a working set area that is a user area of the main memory 12 and c denotes the capacity of a cache line, the number n of block areas corresponding to cache lines of the working set area is expressed as n=M/c. Therefore, the probability that each block area is selected and the probability that each block area is not selected by an access are as follows.

Selection probability=1/n=c/M

Non-selection probability=1−c/M

Next, in the cache memory 35, the target read area capacity Dr has Dr/c number of cache lines and the target write area capacity Dw has Dw/c number of cache lines. Therefore, by raising the non-selection probability provided above with the respective numbers of cache lines, respective cache miss probabilities Hr and Hw of the read area 35_r and the write area 35_w are expressed as follows.

Hr=(1−c/M)^{Dr/c} (5)

Hw=(1−c/M)^{Dw/c} (6)

The cache miss probabilities Hr and Hw expressed by expressions (5) and (6) above vary based on the capacity M of the working set area in the main memory managed by the CPU core. The capacity M is dependent on the process being processed or the like.

Returning now to FIG. 5, the replacement criteria generation circuit 34 includes a Dr, Dw generation circuit 348 that generates the target read area capacity Dr and the target write area capacity Dw. The Dr, Dw generation circuit 348 calculates, or generates by referencing a lookup table, capacities Dr and Dw that minimize an average value of access times to the main memory when a cache miss occurs as represented by expression (2) provided above.

The expression (2) representing the average access time P1 upon a cache miss described earlier is as follows.

P1=Er*(Tr*Hr)+Ew*(Tw*Hw) (2)

In addition, the read probability Er and the write probability Ew in a given process are as represented by the following expressions (3) and (4) described earlier.

Er=roundup(256*er/(er+ew)) (3)

Ew=roundup(256*ew/(er+ew)) (4)

Furthermore, the cache miss probabilities Hr and Hw are as represented by the following expressions (5) and (6) described earlier.

Hr=(1−c/M)^{Dr/c} (5)

Hw=(1−c/M)^{Dw/c} (6)

Moreover, memory latencies Tr and Tw are obtained as fixed values according to characteristics of the main memory. By plugging the latencies Tr, Tw, as well as Er, Ew, Hr, and Hw (expressions (3), (4), (5), and (6)) which vary depending on an execution state of the process, into expression (2), the average access time P1 upon a cache miss is revealed to assume a minimum value in accordance with Dr/Dw. In consideration thereof, the Dr, Dw generation circuit 348 generates the target read area capacity and the target write area capacity Dr and Dw or a capacity ratio Dr/Dw that causes the average access time P1 upon a cache miss to assume a minimum value. The target read area capacity and the target write area capacity Dr and Dw are to be used as replacement criteria in a first embodiment to be described below.

The replacement criteria generation circuit 34 further includes a weight value generation circuit 349. The weight value generation circuit obtains a read weight value WV_r and a write weight value WV_w based on the target read area capacity and the target write area capacity Dr and Dw, the read probability Er, and the write probability Ew as follows.

WV_r=Dr/Er (7)

WV_w=Dw/Ew (8)

These weight values are to be used as replacement criteria in second and third embodiments to be described later.

### First Embodiment

In the first embodiment, as illustrated in FIGS. 2 and 4, the cache control circuit 33 includes the cache hit determination circuit 331 that determines whether or not a memory access instruction results in a cache hit and the cache line replacement control circuit 332 that performs replacement control of a cache line in the cache memory when a cache miss occurs. Furthermore, the cache control circuit 33 includes the replacement criteria generation circuit 34 that generates replacement criteria.

In addition, as illustrated in FIG. 5, based on the read probability Er representing an occurrence probability of read instructions and the write probability Ew representing an occurrence probability of write instructions among memory access instructions, the read time (latency) Tr and the write time (latency) Tw of the main memory, and respective cache miss probabilities Hr and Hw of the target read area 35_r and the target write area 35_w in the cache memory, the replacement criteria generation circuit 34 generates the target read area capacity Dr and the target write area capacity Dw that minimize the average memory access time P1 needed when accessing the main memory in response to a cache miss.

The capacities Dr and Dw can be generated by calculating Dr/Dw that minimizes the average memory access time P1 (expression (2)) upon a cache miss when varying Dr/Dw. Alternatively, the capacities Dr and Dw can be generated by creating, in advance, a lookup table of capacity ratios Dr/Dw that minimize the average memory access time P1 with respect to combinations of a plurality of Er*Tr/Ew*Tw and a plurality of M, and referencing the lookup table.

In the first embodiment, when a cache miss occurs, the cache line replacement control circuit 332 selects a replacement target cache line to be flushed from the cache memory based on the capacities Dr and Dw (the capacity ratio Dr/Dw) that minimize the average memory access time P1. Subsequently, data of the selected cache line is written back to the main memory when needed and accessed data of the main memory is registered in the cache line.

Hereinafter, a specific description of cache control according to the first embodiment will be given.

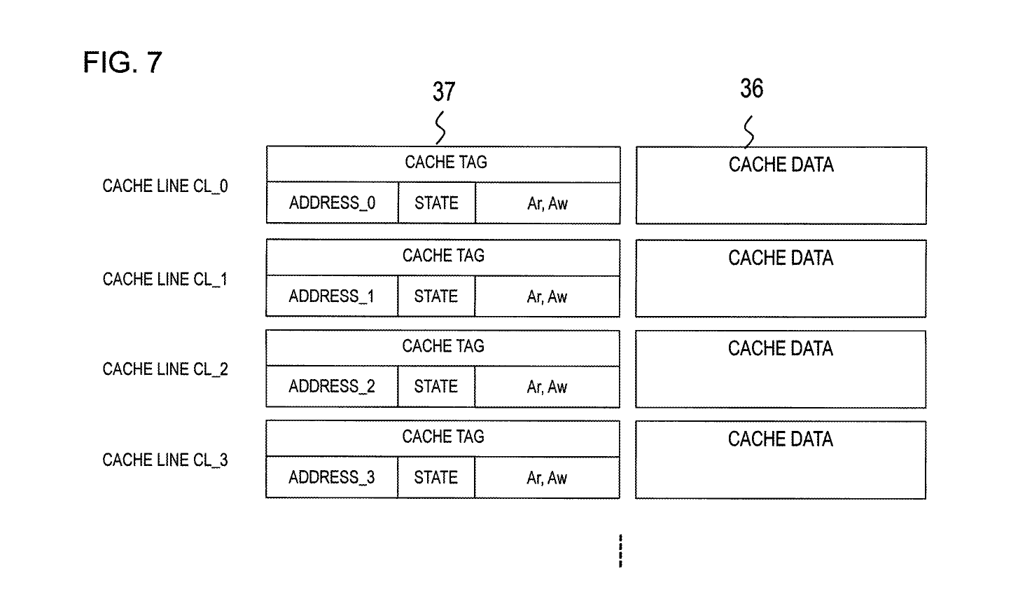

FIG. 7 is a diagram illustrating a configuration of a cache tag memory in a cache memory according to the first embodiment. As is apparent from a comparison with FIG. 3, each cache line CL of the cache tag memory 37 illustrated in FIG. 7 stores the number of reads Ar and the number of writes Aw among memory access instructions having accessed each cache line as criteria information. In addition, each cache line CL includes address information ADDRESS and status information STATE as described earlier with reference to FIG. 3.

Although a detailed description will be given later, in the first embodiment, the cache control unit compares the number of reads Ar and the number of writes Aw in a cache tag upon a cache miss, determines a cache line to be a read cache line when Ar>Aw, and determines the cache line to be a write cache line when Ar<Aw. In addition, the cache control unit assumes a ratio of the number of determined read cache lines to the number of determined write cache lines to be a ratio of a current read area to a current write area. Furthermore, the cache control unit compares a current ratio with a ratio between the target write area capacity Dr and the target write area capacity Dw and determines whether to select a replacement target cache line from the read area or from the write area. Finally, the cache control unit selects the replacement target cache line by the LFU scheme or the LRU scheme from whichever area is selected.

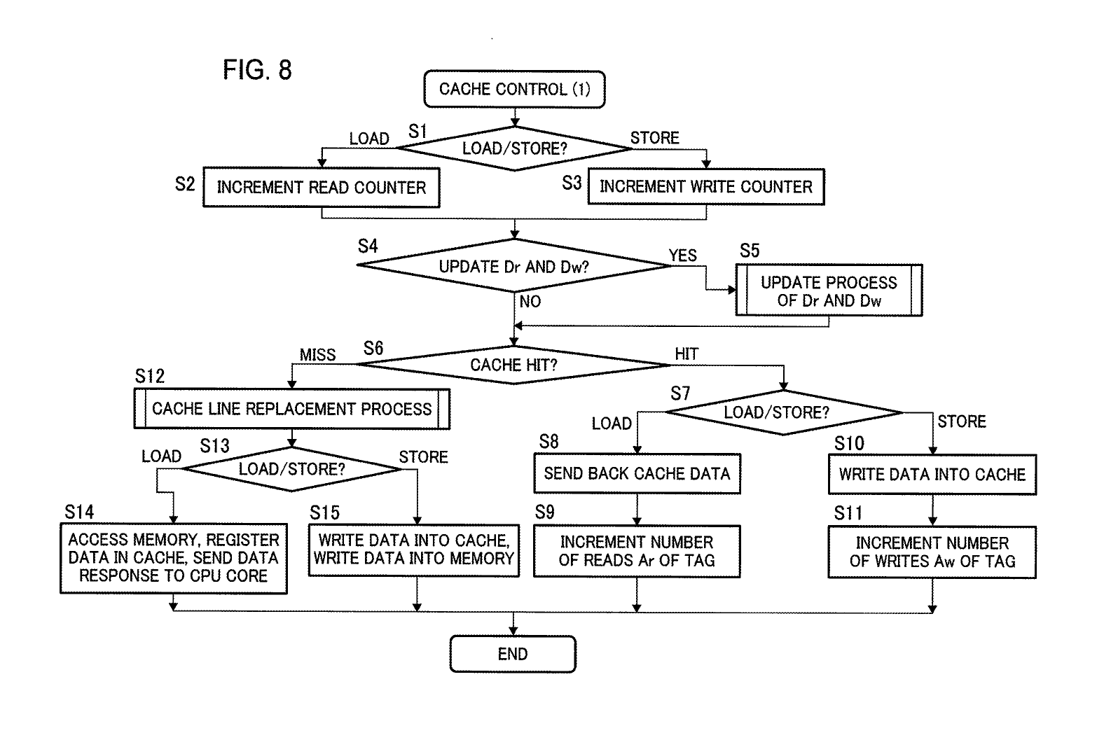

FIG. 8 is a flow chart illustrating cache control by the cache control unit 32 according to the first embodiment. The processes illustrated in the flow chart in FIG. 8 include processes by the cache control circuit 33 and the replacement criteria generation circuit 34 in the cache control unit 32. First, depending on whether a memory access instruction is a load instruction (a read instruction) or a store instruction (a write instruction) (S1), the cache control unit 32 increments the respectively corresponding read counter 341 or write counter 342 by +1 (S2, S3). As illustrated in FIG. 5, the read counter 341 and the write counter 342 are provided in the replacement criteria generation circuit 34.

Subsequently, when a timing at which the target read area capacity Dr and the target write area capacity Dw are to be updated has arrived (YES in S4), the replacement criteria generation circuit 34 updates the capacities Dr and Dw. The update process is executed by the replacement criteria generation circuit 34. For example, a timing at which the capacities Dr and Dw are to be updated is as follows.

First, whenever processes that are processed by the CPU core are switched, the read counter 341 and the write counter 342 are reset and the capacity M of the working set area is also reset. In addition, when the process is being processed, a ratio of the count values er and ew of the read counter and the write counter varies and, at the same time, the capacity M of the working set area also varies. The capacity M of the working set area increases due to a page fault instruction (page_fault) that requests an increase in the working set area and also changes when switching contexts that are register values in the CPU. Therefore, the capacities Dr and Dw generated based on these values er, ew, and M which vary during processing of a process also vary. In consideration thereof, in the present embodiment, the capacities Dr and Dw are updated based on the varying count values er and ew and the capacity M of the working set area at a sufficiently shorter timing than the switching timing of processes.

Therefore, as the timing at which the capacities Dr and Dw are to be updated, a timing at which an update period elapses on a timer, a timing at which the number er+ew of memory accesses reaches 256, a timing at which a page fault instruction occurs, and the like can be selected.

Next, the cache control unit 32 determines whether or not a cache hit has occurred based on an address of the memory access instruction (S6). In case of a cache hit (HIT in S6), if the memory access instruction is a load instruction (a read instruction) (LOAD in S7), the cache control unit 32 reads out data in the cache memory, sends back the data to the CPU core (data response) (S8), and increments the number of reads Ar in the tag of the hit cache line by +1 (S9). In case of a cache hit (HIT in S6), if the memory access instruction is a store instruction (a write instruction) (STORE in S7), the cache control unit 32 writes the write data into the cache memory (S10), and increments the number of writes Aw in the tag of the hit cache line by +1 (S11).

On the other hand, in the case of a cache miss (MISS in S6), the cache line replacement control circuit 332 of the cache control unit 32 executes a cache line replacement process (S12).

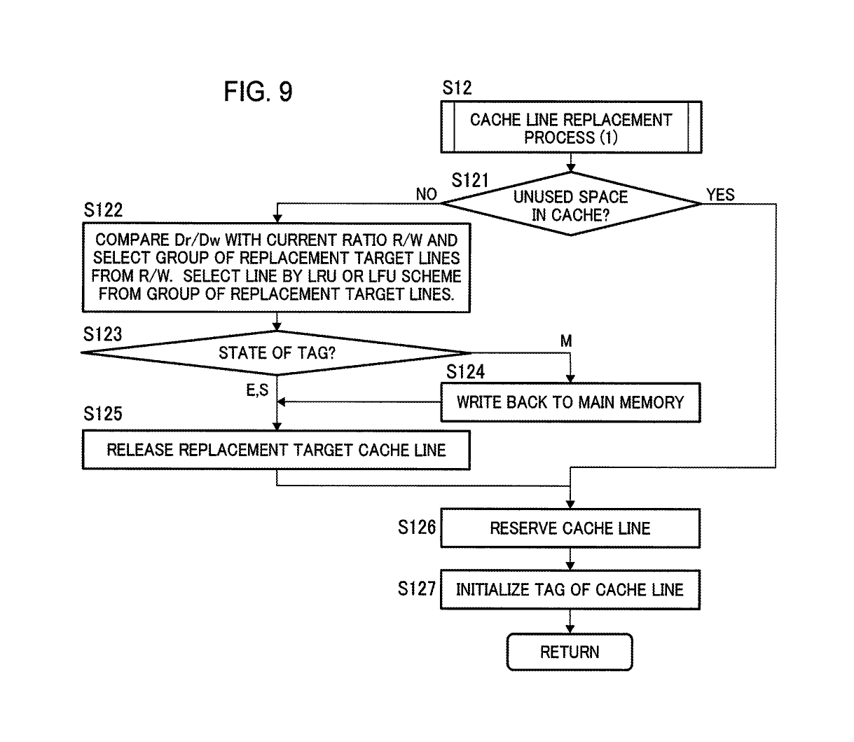

FIG. 9 is a flow chart of a cache line replacement process according to the first embodiment. When there is free space in the cache (YES in S121), the cache line replacement control circuit 332 reserves a free cache line as a cache line to be newly registered (S126) and initializes tag information of the cache line (S127).

On the other hand, when there is no free space in the cache (NO in S121), the cache line replacement control circuit 332 executes a next process S122. Specifically, the cache line replacement control circuit 332 compares the number of reads Ar and the number of writes Aw in a cache tag, determines a cache line to be a read cache line when Ar>Aw, and determines a cache line to be a write cache line when Ar<Aw.

In addition, the cache line replacement control circuit 332 assumes a ratio of the number of determined read cache lines to the number of determined write cache lines to be a current ratio R:W of a read area to a write area in the cache memory. Furthermore, the cache line replacement control circuit 332 compares a current ratio R:W between both areas with a ratio (Dr:Dw) between the target write area capacity Dr and the target write area capacity Dw and determines whether to select the read area or the write area as a replacement target. The selection of the read area or the write area is performed so that the current ratio R:W approaches the target ratio Dr:Dw. In other words, when current ratio R:W>target ratio Dr:Dw, the read area is selected as the replacement target, and when current ratio R:W<target ratio Dr:Dw, the write area is selected as the replacement target.

Finally, the cache line replacement control circuit 332 selects the replacement target cache line by the LFU scheme or the LRU scheme from the selected read area or write area (S122).

Then, when the status information STATE of the replacement target cache line is the M state (Modified: cache memory has been updated but main memory has not been updated) (M in S123), the cache line replacement control circuit 332 writes back the replacement target cache line in the main memory, but when status information STATE of the replacement target cache line is the E state (Exclusive) or the S state (Shared), the cache line replacement control circuit 332 releases (or invalidates) the replacement target cache line without writing it back (S125). Subsequently, the cache line replacement control circuit reserves the released cache line as a cache line to which data is to be newly entered (S126) and initializes information of the tag of the cache line (S127).

As described above, in the first embodiment, the cache line replacement control circuit selects a cache line in the read area with a large number of reads or the write area with a large number of writes in the cache memory as a replacement target cache line so that the read area and the write area in the cache memory approach the capacities Dr and Dw of a target read area and a target write area which minimize the average memory access time P1 upon a cache miss. By performing such replacement control, a ratio between the read area and the write area in the cache memory approaches a ratio of the capacities Dr and Dw of the target read area and the target write area and the main memory access time upon a cache miss can be minimized.

### Second Embodiment

In the second embodiment, as illustrated in FIGS. 2 and 4, the cache control circuit 33 includes the cache hit determination circuit 331 that determines whether or not a memory access instruction results in a cache hit and the cache line replacement control circuit 332 that performs replacement control of a cache line in the cache memory when a cache miss occurs. Furthermore, the cache control circuit 33 includes the replacement criteria generation circuit 34 that generates replacement criteria.

In addition, as illustrated in FIG. 5, based on the read probability Er representing an occurrence probability of read instructions and the write probability Ew representing an occurrence probability of write instructions among memory access instructions, the read time (latency) Tr and the write time (latency) Tw of the main memory, and respective cache miss probabilities Hr and Hw of the target read area 35_r and the target write area 35_w in the cache memory, the replacement criteria generation circuit 34 generates the target read area capacity Dr and the target write area capacity Dw that minimize the average memory access time P1 needed when accessing the main memory in response to a cache miss. So far, the second embodiment is no different from the first embodiment.

In the replacement criteria generation circuit 34 according to the second embodiment, the weight value generation circuit 349 further generates a read weight value WVr and a write weight value WVw based on the read probability Er, the write probability Ew, the target read area capacity Dr, and the target write area capacity Dw. As described earlier, the read weight value WVr and the write weight value WVw are calculated as follows.

WVr=Dr/Er (7)

WVw=Dw/Ew (8)

In addition, every time a read or a write occurs at the cache line or, in other words, every time a cache hit occurs, the cache control circuit 33 adds the weight value WVr or WVw corresponding to read or write to the corrected access frequency stored in the tag of the cache line and overwrites with the sum. Therefore, the corrected access frequency CAF may be represented by expression (9) below.

CAF=er*WVr+ew*WVw (9)

As described above, the corrected access frequency CAF is the number of accesses er and ew from the start of a given process having been corrected by multiplying by weight values and is referred to as the corrected number of accesses. However, since the number of accesses within a given process processing time is corrected, hereinafter, the term “corrected access frequency” will be used.

In addition, when a cache miss occurs, the cache line replacement control circuit 332 selects a cache line with a lowest corrected access frequency CAF among all cache lines in the cache memory as the replacement target cache line. In other words, in the second embodiment, a replacement target cache line upon a cache miss is selected by the LFU scheme.

In the second embodiment, cache lines are not divided into a read area with a large number of reads and a write area with a large number of writes as is the case with the first embodiment. In the second embodiment, a cache line with a lowest corrected access frequency CAF is selected as a replacement target from all cache lines. However, the corrected access frequency CAF recorded in a cache tag is a sum of a value obtained by correcting the number of reads er using the read weight value WVr and a value obtained by correcting the number of writes ew using the write weight value WVw. In other words, the corrected access frequency CAF is an access frequency in which the number of writes has been corrected so as to apparently increase. Therefore, due to the cache line replacement control circuit selecting a cache line with the lowest corrected access frequency as a replacement target, a cache line with a large number of writes remains in the cache memory longer than a cache line with a larger number of reads. Furthermore, even if a cache line has a small number of writes, the cache line remains in the cache memory for a long time if a certain number of writes is performed. As a result, a ratio between the number of cache lines with many reads and the number of cache lines with many writes is controlled so as to approach the ratio between the target read area capacity Dr and the target write area capacity Dw.

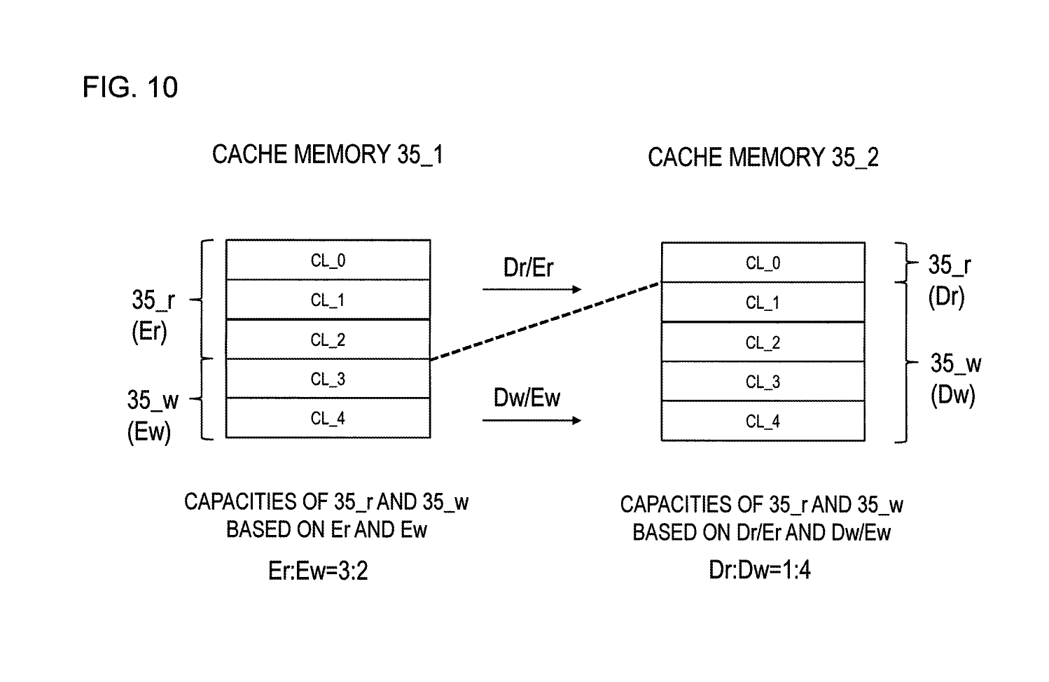

FIG. 10 is a diagram explaining a corrected access frequency and weight values according to the second embodiment. In FIG. 10, a left-side cache memory 35_1 is an example where replacement target cache lines are simply selected and rearranged based on access frequency. In this case, a ratio between the read area 35_r and the write area 35_w equals a ratio between the read probability Er and the write probability Ew. For example, when the ratio between the read probability Er and the write probability Ew among all memory access instructions is Er:Ew=3:2, selecting the cache line with the lowest access frequency causes a ratio between the number of cache lines in the read area 35_r and the number of cache lines in the write area 35_w in the cache memory to approach 3:2 that is equal to Er:Ew.

Meanwhile, a right-side cache memory 35_2 is distributed at a ratio between the target read area capacity Dr and the target write area capacity Dw which minimize the average memory access time P1. Assuming that Dr:Dw=1:4, by controlling the ratio between the number of cache lines in the read area 35_r and the number of cache lines in the write area 35_w in the cache memory to also equal 1:4, the average main memory access time P1 upon a cache miss can be minimized.

In consideration thereof, by multiplying the number of reads er by the read weight value WVr=Dr/Er and multiplying the number of writes ew by the write weight value WVw=Dw/Ew, a ratio between a corrected number of reads er*(Dr/Er) and a corrected number of writes ew*(Dw/Ew) becomes equal to Dr:Dw as shown below. This is due to the fact that er:ew=Er:Ew.

er*(Dr/Er):ew*(Dw/Ew)=Dr:Dw

Therefore, the corrected access frequency CAF can be obtained by adding up the corrected number of reads and the corrected number of reads as in expression (9) below.

CAF=er*WVr+ew*WVw (9)

If the same number of accesses is made to all cache lines, a cache line with a large number of writes is more likely to be retained in the cache memory and a cache line with a large number of reads is more likely to be flushed from the cache memory. Furthermore, if the ratio between reads and writes is the same for all cache lines, the larger the number of accesses, the more likely that a cache line is to be retained in the cache memory, and the smaller the number of accesses, the more likely that a cache line is to be flushed from the cache memory. In addition, even if a large number of accesses are made, a cache line is likely to be flushed from the cache memory if the number of writes is small.

Hereinafter, a specific description of cache control according to the second embodiment will be given.

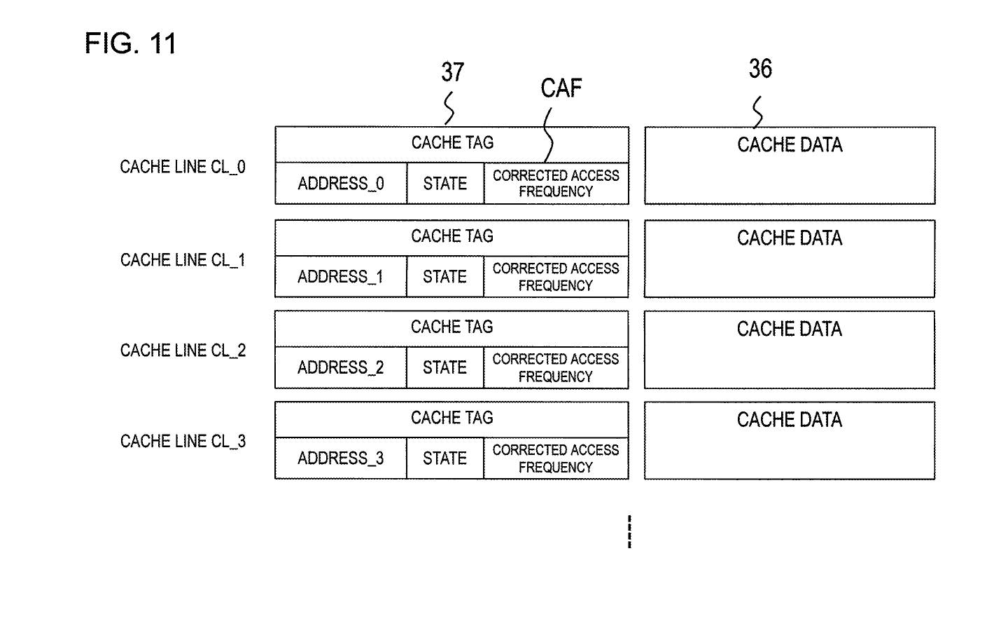

FIG. 11 is a diagram illustrating a configuration of a cache tag memory in a cache memory according to the second embodiment. As is apparent from a comparison with FIG. 3, each cache line CL of the cache tag memory 37 illustrated in FIG. 11 stores the corrected access frequency CAF as criteria information. In addition, each cache line CL includes address information ADDRESS and status information STATE as described earlier with reference to FIG. 3.

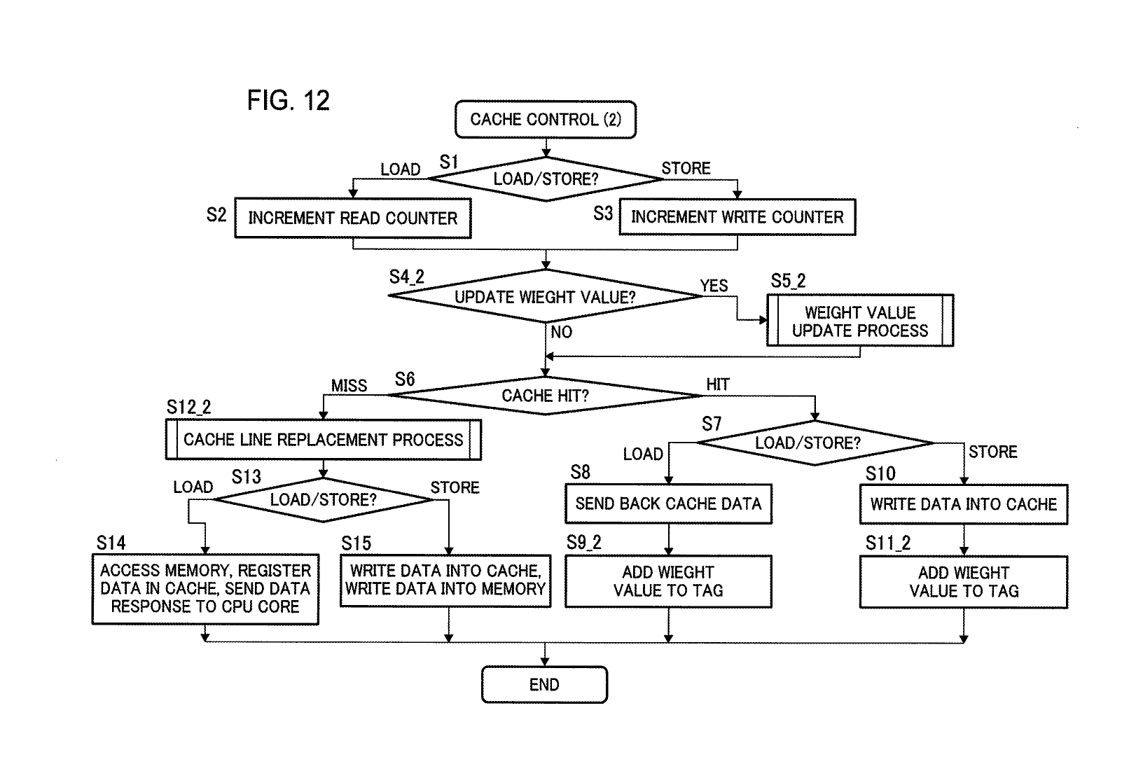

FIG. 12 is a flow chart illustrating cache control by the cache control unit 32 according to the second embodiment. The processes illustrated in the flow chart in FIG. 12 also include processes by the cache control circuit 33 and the replacement criteria generation circuit 34 in the cache control unit 32. In addition, processes in FIG. 12 which differ from the processes in FIG. 8 according to the first embodiment are steps S4_2, S5_2, S9_2, S11_2, and S12_2.

First, depending on whether a memory access instruction is a load instruction (a read instruction) or a store instruction (a write instruction) (S1), the cache control unit 32 increments the respectively corresponding read counter 341 or write counter 342 by +1 (S2, S3).

Subsequently, when a timing at which the weight values WVr=Dr/Er and WVw=Dw/Ew are to be updated has arrived (YES in S4_2), the replacement criteria generation circuit 34 updates the capacities Dr and Dw and updates the weight values WVr and WVw (S5_2). The update process is executed by the replacement criteria generation circuit 34. The method of generating weight values is as described with reference to FIG. 5. In addition, the timing at which the weight values are to be updated is the same as the timing at which the capacities Dr and Dw are to be updated in the first embodiment.

Next, the cache control unit 32 determines whether or not a cache hit has occurred based on an address of the memory access instruction (S6). In the case of a cache hit (HIT in S6), if the memory access instruction is a load instruction (a read instruction) (LOAD in S7), the cache control unit 32 reads out data in the cache memory, sends back the data to the CPU core (data response) (S8), and adds the weight value WVr to the corrected access frequency CAF in the cache tag of the hit cache line (S9_2). In the case of a cache hit (HIT in S6), if the memory access instruction is a store instruction (a write instruction) (STORE in S7), the cache control unit 32 writes the write data into the cache memory (S10), and adds the weight value WVw to the corrected access frequency CAF in the cache tag of the hit cache line (S11_2).

In this manner, in the second embodiment, each time the cache memory is accessed, the corrected access frequency CAF of the tag of the accessed cache line is increased. However, the increased amount is not +1 but the weight value WVr=Dr/Er in the case of a read and the weight value WVw=Dw/Ew in the case of a write.

On the other hand, in the case of a cache miss (MISS in S6), the cache line replacement control circuit 332 of the cache control unit 32 executes a cache line replacement process (S12_2).

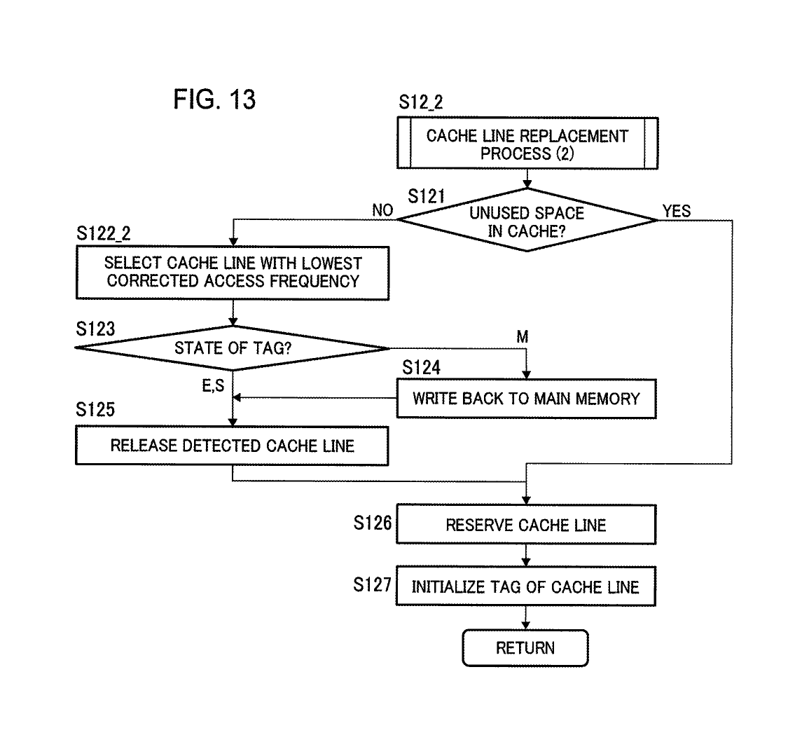

FIG. 13 is a flow chart of a cache line replacement process according to the second embodiment. The cache line replacement process in FIG. 13 is the same as the cache line replacement process according to the first embodiment illustrated in FIG. 9 with the exception of step S122_2.

In FIG. 13, when there is no free space in the cache (NO in S121), the cache line replacement control circuit 332 selects a cache line with the lowest corrected access frequency CAF among all cache lines in the cache memory as the replacement target cache line.

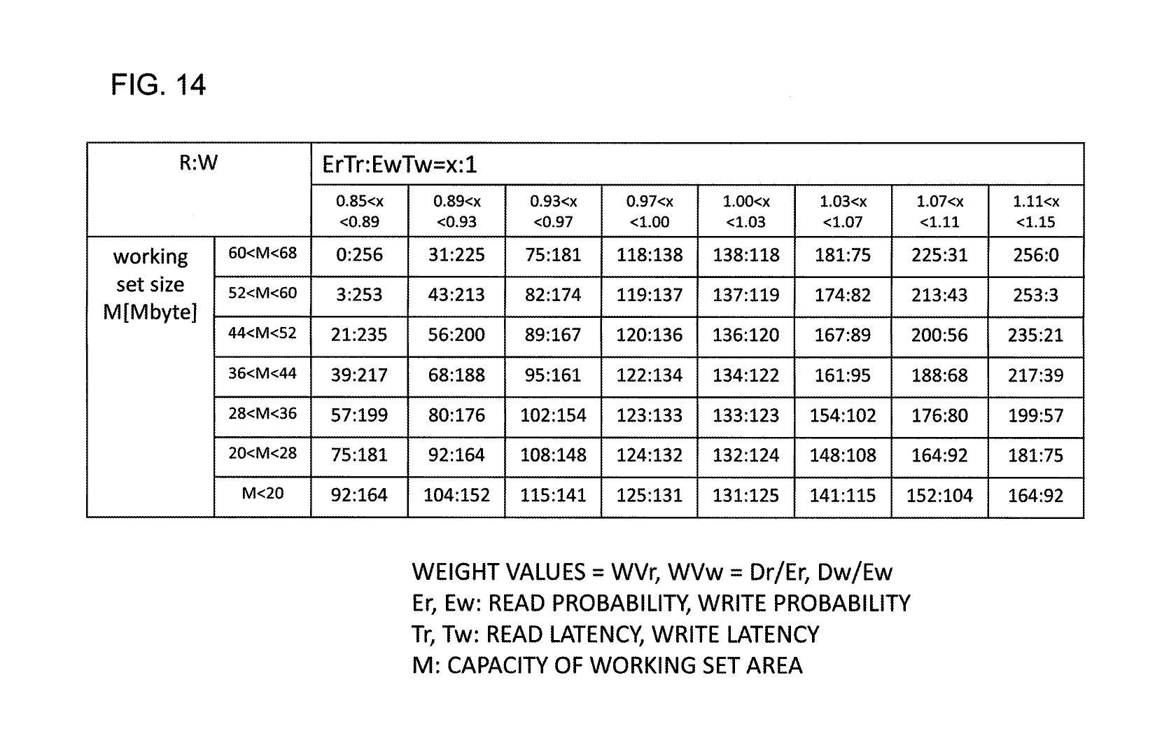

FIG. 14 is a diagram illustrating an example of an optimal weight value lookup table according to the second embodiment. The weight value update process S5_2 illustrated in FIG. 12 can be calculated by the Dr, Dw generation circuit 348 and the weight value generation circuit 349 illustrated in FIG. 5. However, as alternative means, the optimal weight value lookup table in FIG. 14 may be referenced to extract optimal weight values WVr and WVw based on the read probability Er, the write probability Ew, read and write latencies Tr and Tw, and the working set area capacity M.

In the table illustrated in FIG. 14, a horizontal direction represents ErTr/EwTw=x and a vertical direction represents working set area capacity M, and optimal weight values WVr and WVw can be extracted from combinations of both values x and M.

As described above, in the second embodiment, the cache line replacement control circuit performs cache line replacement control by the LFU scheme based on the corrected access frequency obtained by correcting the number of accesses with weight values. In addition, the weight values WVr and WVw reflect the target read area capacity Dr and the target write area capacity Dw which minimize the average memory access time P1 upon a cache miss. As a result, replacement control is performed on the cache lines in the cache memory so as to approach target capacities Dr and Dw. Accordingly, the main memory access time P1 upon a cache miss can be minimized.

### Third Embodiment

In the third embodiment, as illustrated in FIGS. 2 and 4, the cache control circuit 33 includes the cache hit determination circuit 331 that determines whether or not a memory access instruction results in a cache hit and the cache line replacement control circuit 332 that performs replacement control of a cache line in the cache memory when a cache miss occurs. Furthermore, the cache control circuit 33 includes the replacement criteria generation circuit 34 that generates replacement criteria.

In addition, the replacement criteria generation circuit 34 generates a read weight value WVr and a write weight value WVw with the circuit illustrated in FIG. 5 in a similar manner to the second embodiment.

In the third embodiment, the cache line replacement control circuit 332 selects a replacement target cache line by the LRU scheme. Therefore, when a cache hit occurs, the cache control unit 32 increments the number of reads Ar or the number of writes Aw as criteria information of a tag of a cache line and updates an access time that is the time at which the cache hit had occurred. In addition, when a cache miss occurs, for all cache lines, the cache line replacement control circuit 332 first determines whether each cache line is a line with many reads or a line with many writes based on the number of reads Ar and the number of writes Aw. Next, for all cache lines, the cache line replacement control circuit 332 selects, as a replacement target, a cache line with a longest corrected time difference DT/WVr or DT/WVw obtained by dividing a time difference DT between the access time of the cache tag and a current time upon a cache miss by the weight value WVr or WVw. As far as which weight value WVr or WVw is to be used to divide the time difference DT, a weight value is selected which corresponds to a result of a determination made based on the number of reads Ar and the number of writes Aw regarding whether a cache line is a cache line with many reads or a cache line with many writes.

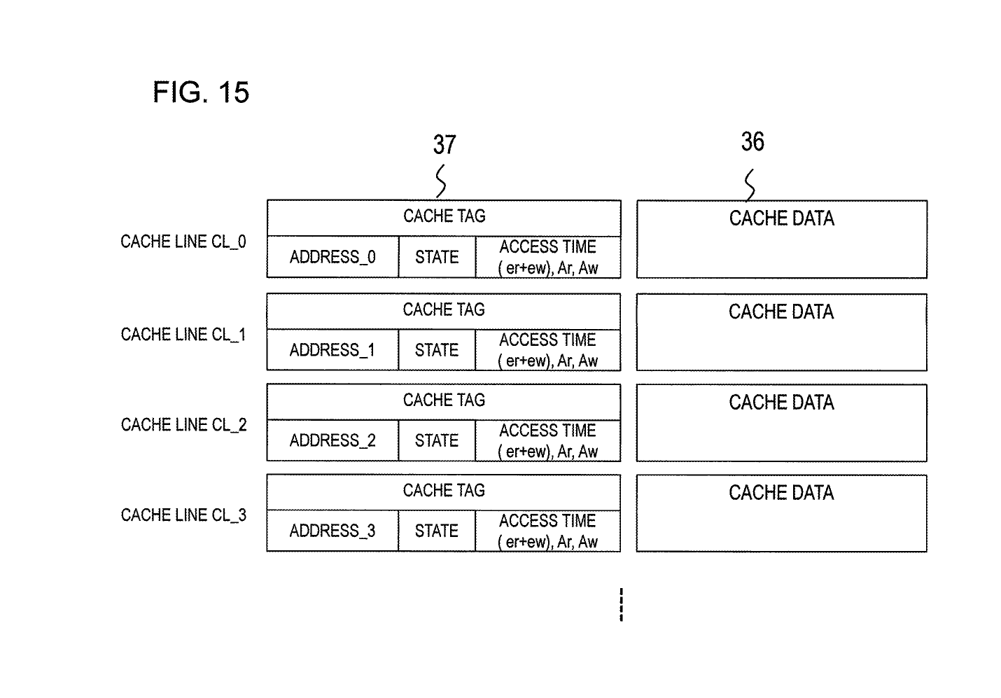

FIG. 15 is a diagram illustrating a configuration of a cache tag memory in a cache memory according to the third embodiment. As is apparent from a comparison with FIG. 3, each cache line CL of the cache tag memory 37 illustrated in FIG. 15 stores an access time (or the number of accesses er+ew at the time of access), and the number of reads Ar and the number of writes Aw with respect to the cache line as criteria information.

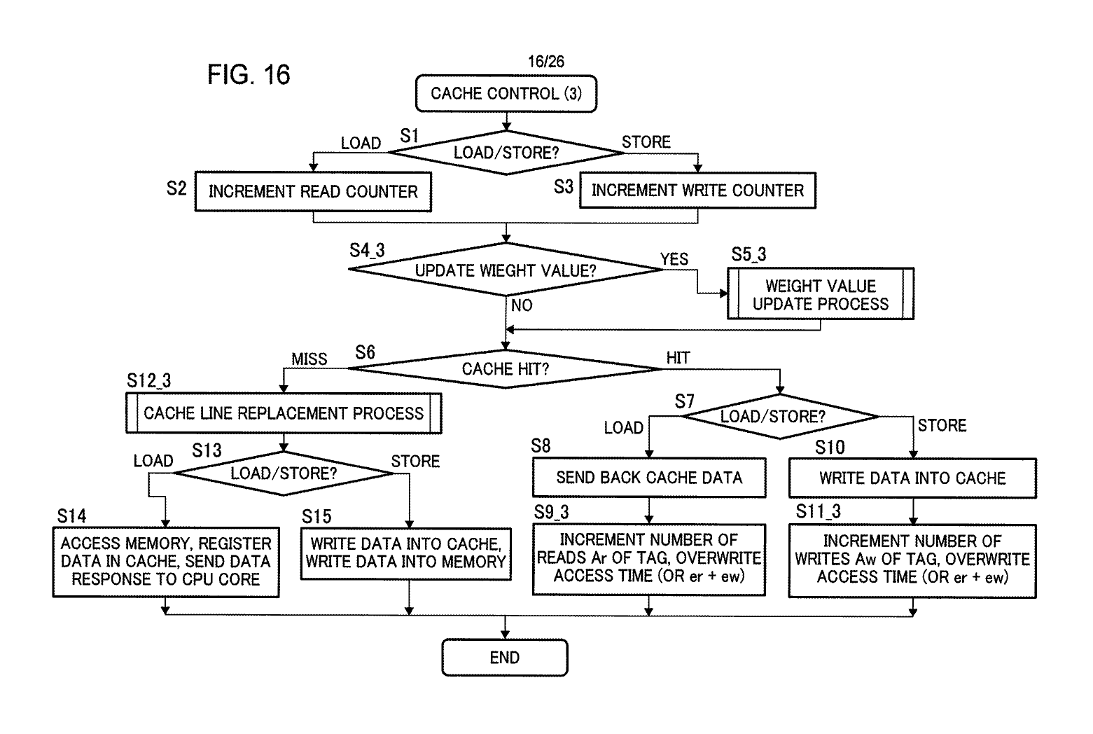

FIG. 16 is a flow chart illustrating cache control by the cache control unit 32 according to the third embodiment. The processes illustrated in the flow chart in FIG. 16 also include processes by the cache control circuit 33 and the replacement criteria generation circuit 34 in the cache control unit 32. In addition, processes in FIG. 16 which differ from the processes in FIG. 8 according to the first embodiment are steps S4_3, S5_3, S9_3, S11_3, and S12_3. Steps S4_3 and S5_3 in FIG. 16 are the same as steps S4_2 and S5_2 in FIG. 12 according to the second embodiment.

First, depending on whether a memory access instruction is a load instruction (a read instruction) or a store instruction (a write instruction) (S1), the cache control unit 32 increments the respectively corresponding read counter (er) 341 or write counter (ew) 342 by +1 (S2, S3).

Subsequently, when a timing at which the weight values WVr=Dr/Er and WVw=Dw/Ew are to be updated has arrived (YES in S4_3), the replacement criteria generation circuit 34 updates the capacities Dr and Dw and updates the weight values WVr and WVw (S5_3). The update process is executed by the replacement criteria generation circuit 34. The method of generating weight values is as described with reference to FIG. 5. In addition, the timing at which the weight values are to be updated is the same as the timing at which the weight values WVr and WVw are to be updated in the second embodiment.

Next, the cache control unit 32 determines whether or not a cache hit has occurred based on an address of the memory access instruction (S6). In case of a cache hit (HIT in S6), if the memory access instruction is a load instruction (a read instruction) (LOAD in S7), the cache control unit 32 reads out data in the cache memory, sends back the data to the CPU core (data response) (S8), increments the number of reads Ar in the cache tag of the hit cache line by +1, and updates the access time (S9_3). In case of a cache hit (HIT in S6), if the memory access instruction is a store instruction (a write instruction) (STORE in S7), the cache control unit 32 writes the write data into the cache memory (S10), increments the number of writes Aw in the cache tag of the hit cache line by +1, and updates the access time (S11_3).

On the other hand, in the case of a cache miss (MISS in S6), the cache line replacement control circuit 332 of the cache control unit 32 executes a cache line replacement process (S12_3).

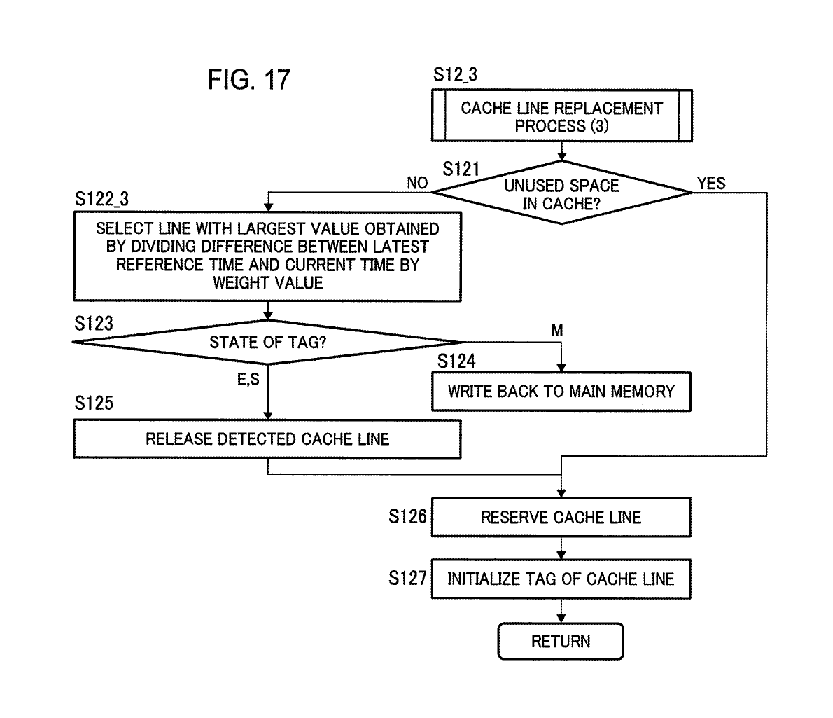

FIG. 17 is a flow chart of a cache line replacement process according to the third embodiment. The cache line replacement process in FIG. 17 is the same as the cache line replacement processes according to the first and second embodiments illustrated in FIGS. 9 and 13 with the exception of step S122_3.

In FIG. 17, when there is no free space in the cache (NO in S121), the cache line replacement control circuit 332 selects a cache line with the longest corrected time difference DT/WVr or DT/WVw among all cache lines in the cache memory as the replacement target (S122_3).

At this point, the cache line replacement control circuit determines whether a cache line is a read line or a write line based on the number of reads Ar and the number of writes Aw in the cache tag. As far as determination criteria is concerned, for example, a read line is determined when Ar>Aw and a write line is determined when Ar<Aw. Alternatively, as the determination criteria, a read line may be determined when Ar>Aw+α and a write line may be determined when Ar<Aw+α. An α value is used as described above because, in general processes, the number of reads tends to be larger than the number of writes and using a corrects this tendency.

In addition, the cache line replacement control circuit calculates a time difference DT between the access time in the cache tag and the current time, and calculates corrected time differences DT/WVr and DT/WVw. Subsequently, the cache line replacement control circuit selects a cache line with a longest corrected time difference among all cache lines as the replacement target.

The cache line replacement process illustrated in FIG. 17 is the same as those of the first and second embodiments illustrated in FIGS. 9 and 13 with the exception of step S22_3 described above.

In the third embodiment, the number of memory accesses er+ew obtained by adding up a counter value er of the read counter and counter value ew of the write counter may be used instead of time. In other words, upon a cache hit, the cache control unit records the number of memory accesses er+ew during an access in place of access time in a tag, and upon a cache miss, the cache control unit calculates a difference in numbers between the number of memory accesses er+ew upon an access in the tag and the number of memory accesses er+ew upon a cache miss and calculates a corrected difference in numbers obtained by dividing the difference in numbers by weight values WVr and WVw. Subsequently, the cache line replacement control circuit selects a cache line with the largest corrected difference in numbers among all cache lines as a replacement target. In this variation, the number of memory accesses er+ew is used as the time.

As described above, in the third embodiment, upon a cache miss, the cache line replacement control circuit obtains a corrected time difference (or a corrected difference in numbers of memory accesses) by dividing a time difference (or a difference in numbers) between an immediately-previous access time (or the immediately-previous number of memory accesses) and the current time (or the current number of memory accesses) for each cache line by a weight value, and selects a cache line with the longest (or largest) corrected time difference (or corrected difference in numbers) as a replacement target. As a result, the cache memory can be controlled to the target read area capacity Dr and the target write area capacity Dw.

[Various Timing Charts]

Hereinafter, various operations when the present embodiment is applied will be described with reference to timing charts.

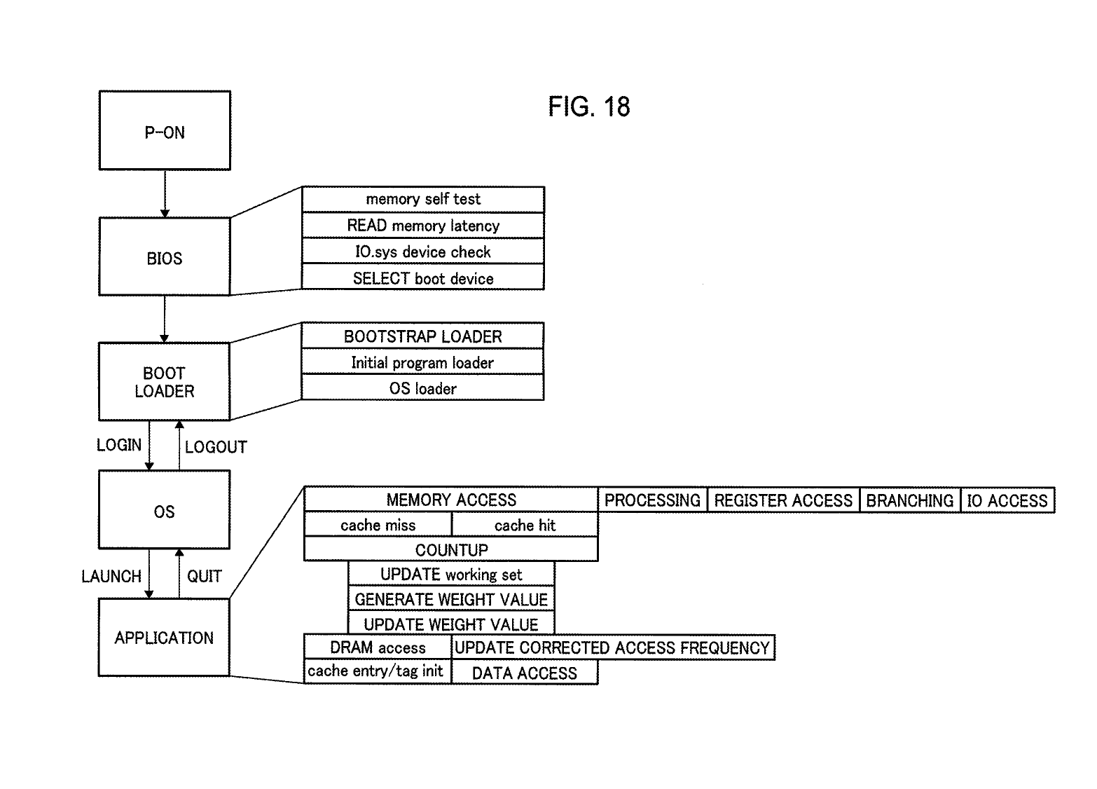

FIG. 18 is a state transition diagram from power-on of an information processing apparatus including a CPU (processing device) to execution of an application. First, when the information processing apparatus is powered on (P-ON), a BIOS (Basic IO System) is executed (BIOS). Due to the BIOS being executed by the CPU, an initial test of a main memory is performed by a self-test circuit in the memory. At this point, read and write latencies are read from the main memory. Furthermore, connections of IO devices are checked and a boot device is selected.

Next, a portion to be executed first in the boot device is executed from a bootstrap loader and a kernel module is loaded to the main memory. Accordingly, execution authority is transferred to an OS (OS) and, thereafter, the main memory is virtualized and the present embodiment can be executed.

Next, in response to a login by a user, a user mode is entered and the OS loads an application program to a user space in the main memory and executes the application program (APPLICATION). The application program combines instructions for performing arithmetic processing, access to a CPU register, main memory access, branching, IO access, and the like. The present embodiment is executed during a main memory access.

A memory access is as described earlier, and as illustrated in FIG. 18, the cache control unit performs a cache hit determination, counts up the read counter or the write counter, and performs an update process at a timing of updating a weight value. In case of a cache miss, an access to the main memory occurs, a cache line replacement process is performed, and a new cache entry is registered. In addition, in case of a cache hit, a corrected access frequency is updated and data in the cache memory is accessed. The description above applies to the second embodiment that uses a corrected access frequency.

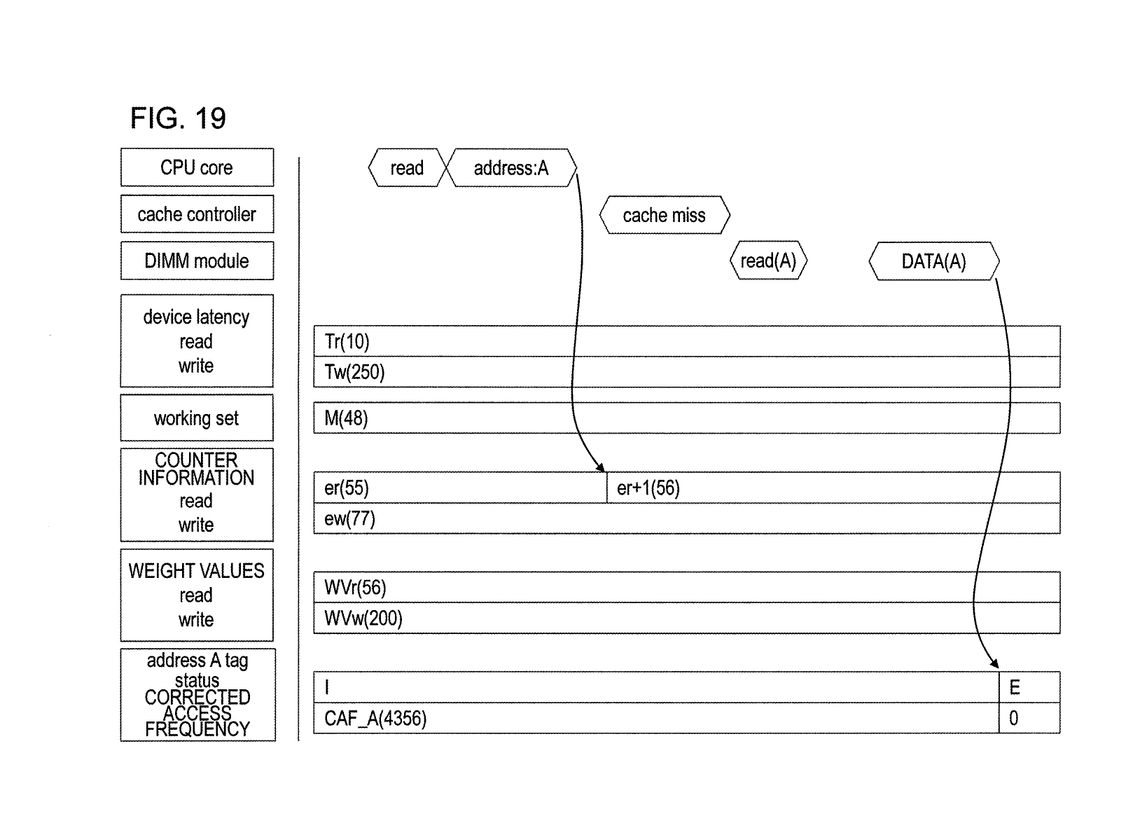

FIG. 19 is a timing chart illustrating an operation when a cache miss occurs as a result of a read instruction to address A. First, the CPU core issues a read instruction (Read) together with address A. When the cache control unit determines a cache miss, a read access is executed to a DIMM module that is the main memory via the memory access controller and data at address A is output. The cache control unit increments a counter value er of the read counter to er+1. In addition, the cache control unit registers the data acquired by accessing the main memory in a replaced cache line and, at the same time, respectively initializes status information of the cache tag to the E state and the corrected access frequency CAF to 0.

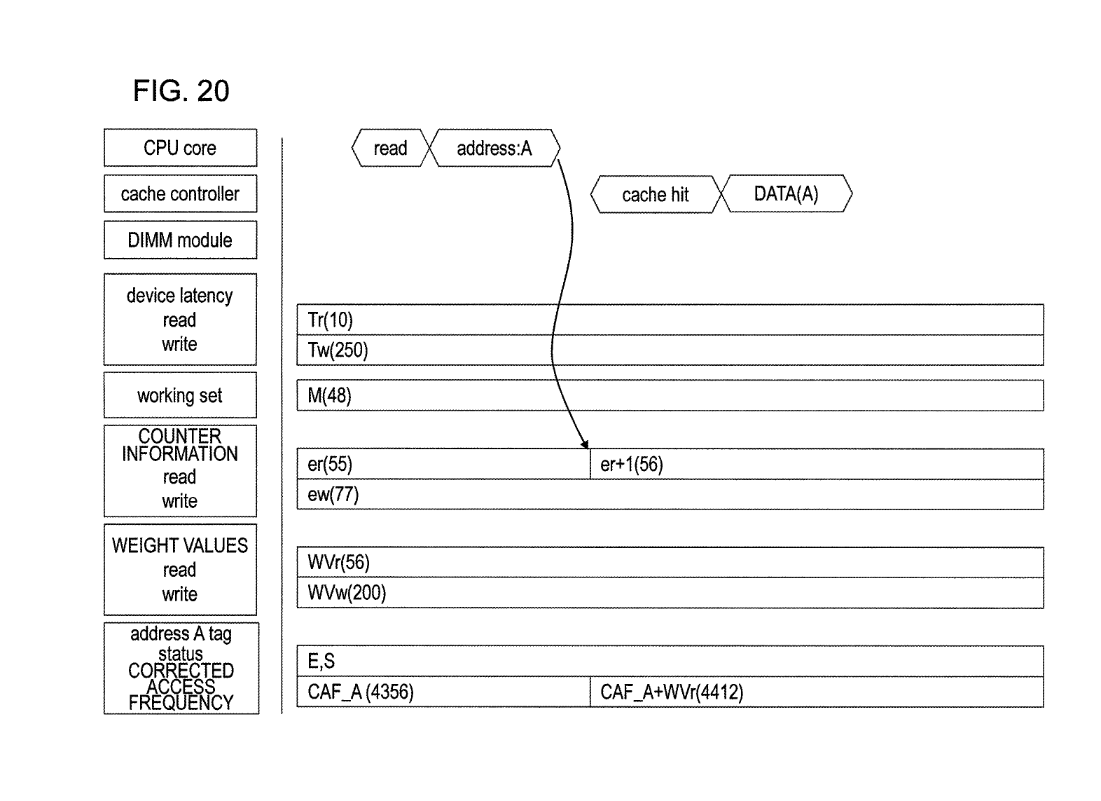

FIG. 20 is a timing chart illustrating an operation when a cache hit occurs as a result of a read instruction to address A. The CPU core issues a read instruction to address A and the cache control unit determines a cache hit and accesses data in the cache memory. In this case, the cache control unit increments a counter value er of the read counter to er+1 and adds a read weight value WVr to the corrected access frequency CAF in the tag of the accessed cache line.

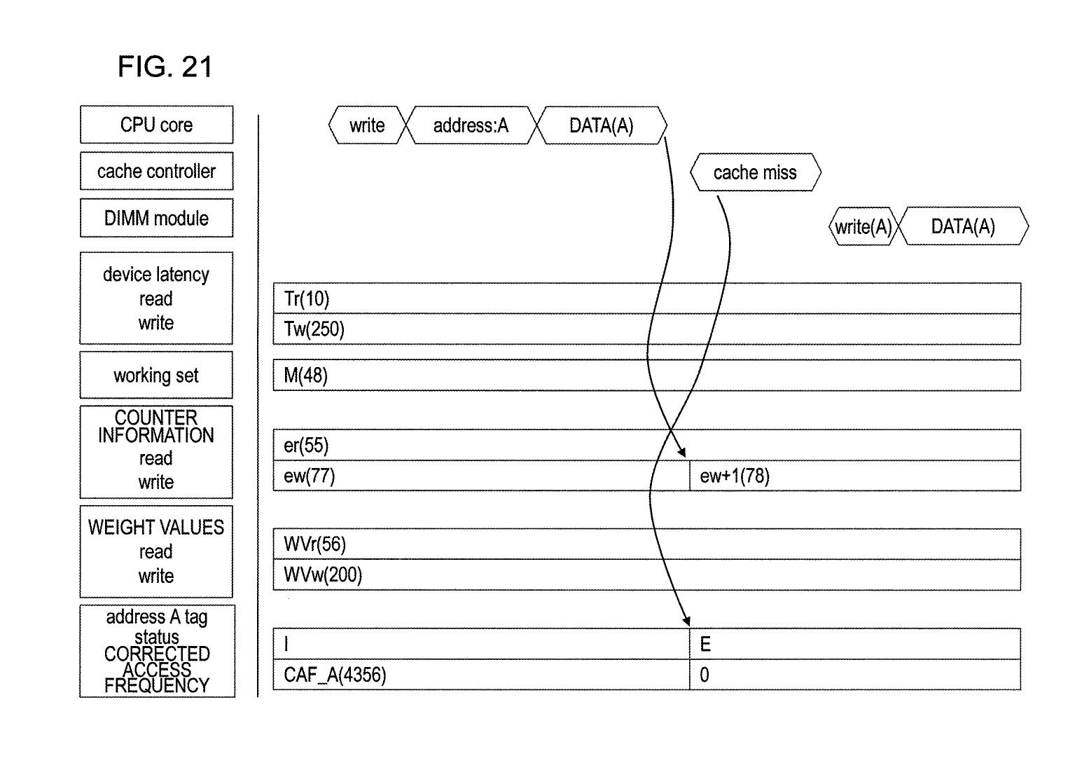

FIG. 21 is a timing chart illustrating an operation when a cache miss occurs as a result of a write instruction to address A. The cache control unit determines a cache miss and increments a counter value ew of the write counter and, at the same time, replaces the cache line and respectively initializes status information of the tag and the corrected access frequency CAF of the newly-entered cache line to the E state and 0. In addition, the cache control unit writes data into the new cache line and accesses the main memory to write the data.

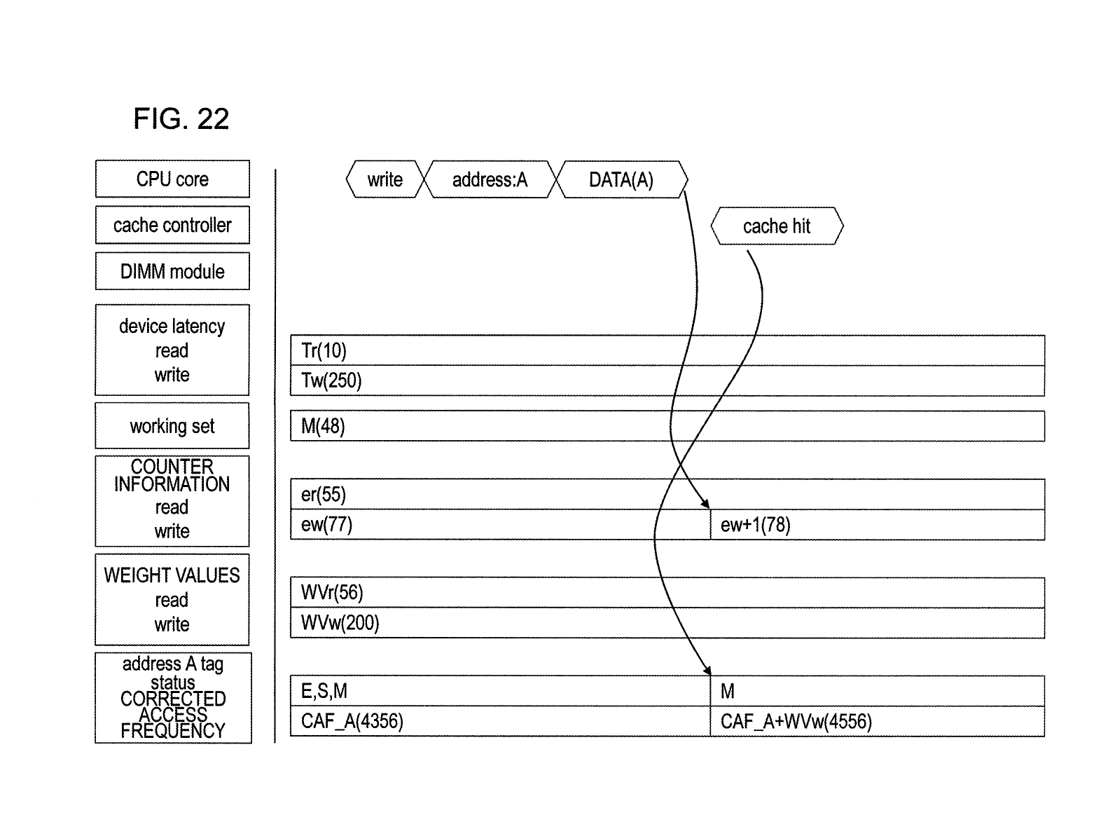

FIG. 22 is a timing chart illustrating an operation when a cache hit occurs as a result of a write instruction to address A. The cache control unit determines a cache hit, increments the counter value ew of the write counter and, at the same time, writes data into the cache line where the cache hit had occurred, changes status information of the tag of the cache line to the M state and adds a weight value WVw to the corrected access frequency CAF.

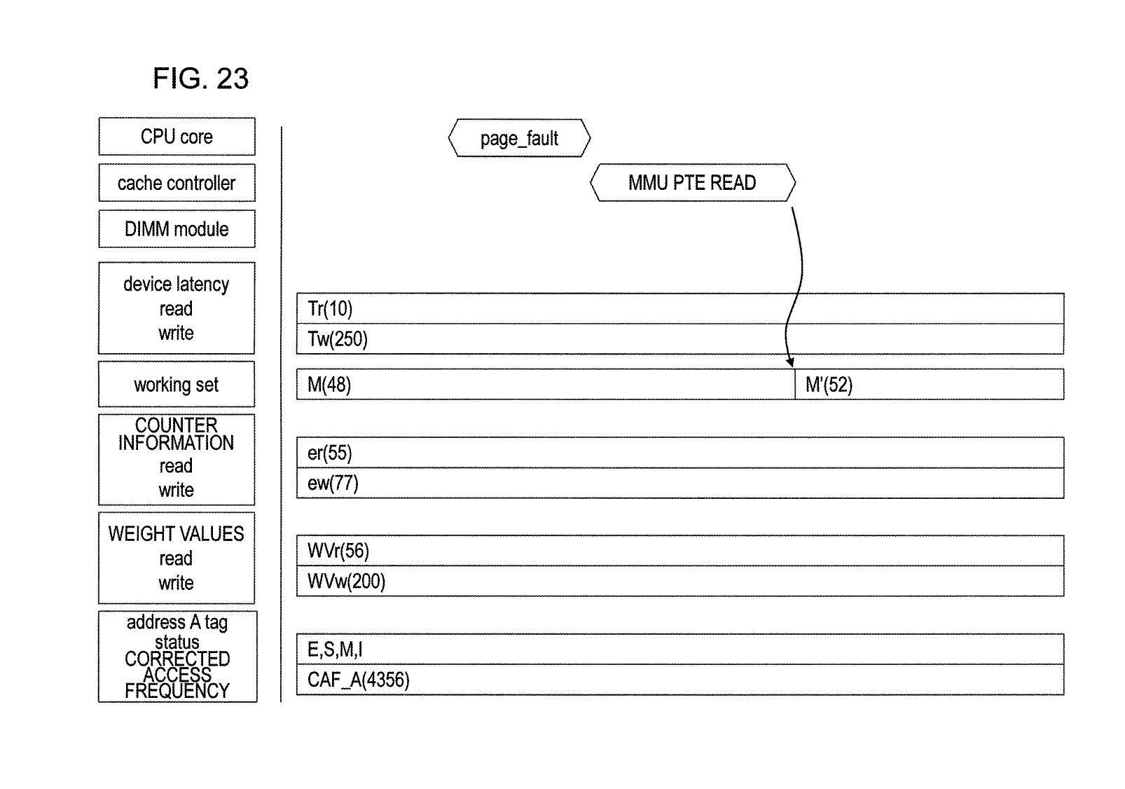

FIG. 23 is a timing chart illustrating an update process of the working set area capacity M. When the CPU core issues a page fault instruction, the capacity M of a working set area in the main memory is increased and a page table is updated. In addition, the cache control unit reads the updated page table from the memory controller and records the updated page table in the capacity register of the working set area. As a result, the capacity M increases from 48 bytes to 52 bytes.

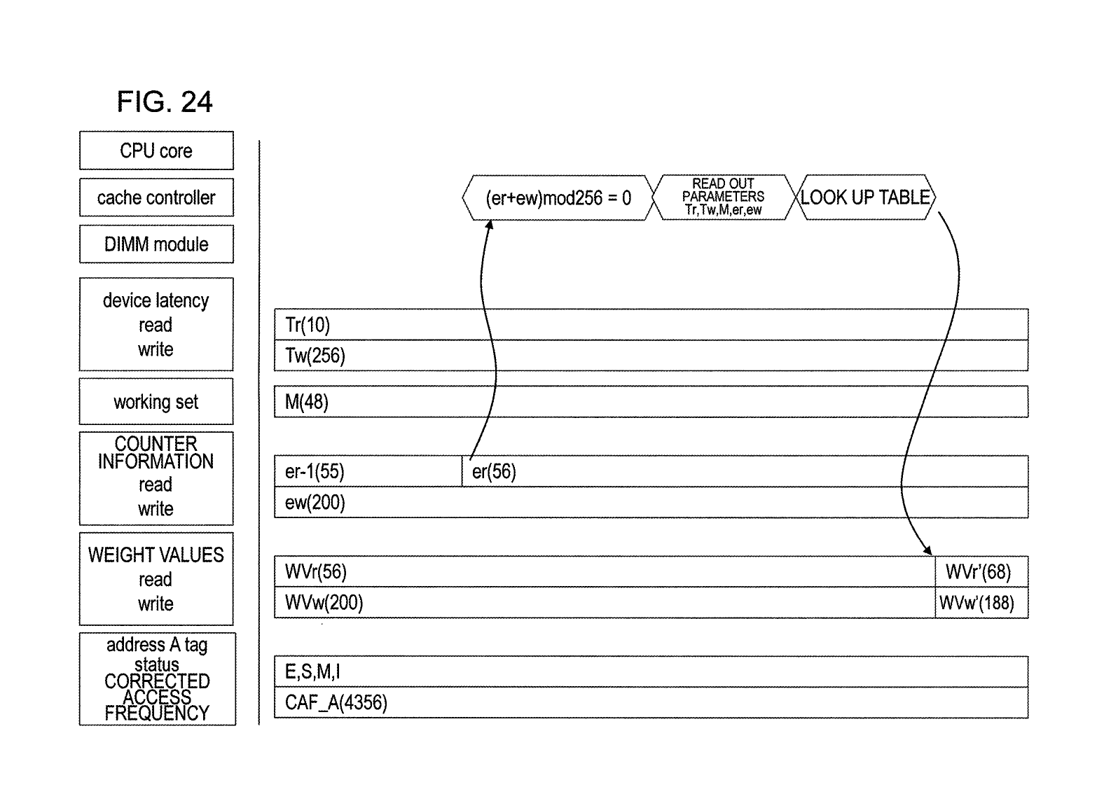

FIG. 24 is a diagram illustrating an update process of a weight value. In this example, as described earlier, when a sum er+ew of the counter value er of the read counter and the counter value ew of the write value equals a multiple of 256, the memory control unit reads out parameters Tr, Tw, M, er, and ew of a group of registers, looks up an optimal weight value table and extracts an optimal weight value, and updates the weight values WVr and WVw to new weight values WVr′ and WVw′.

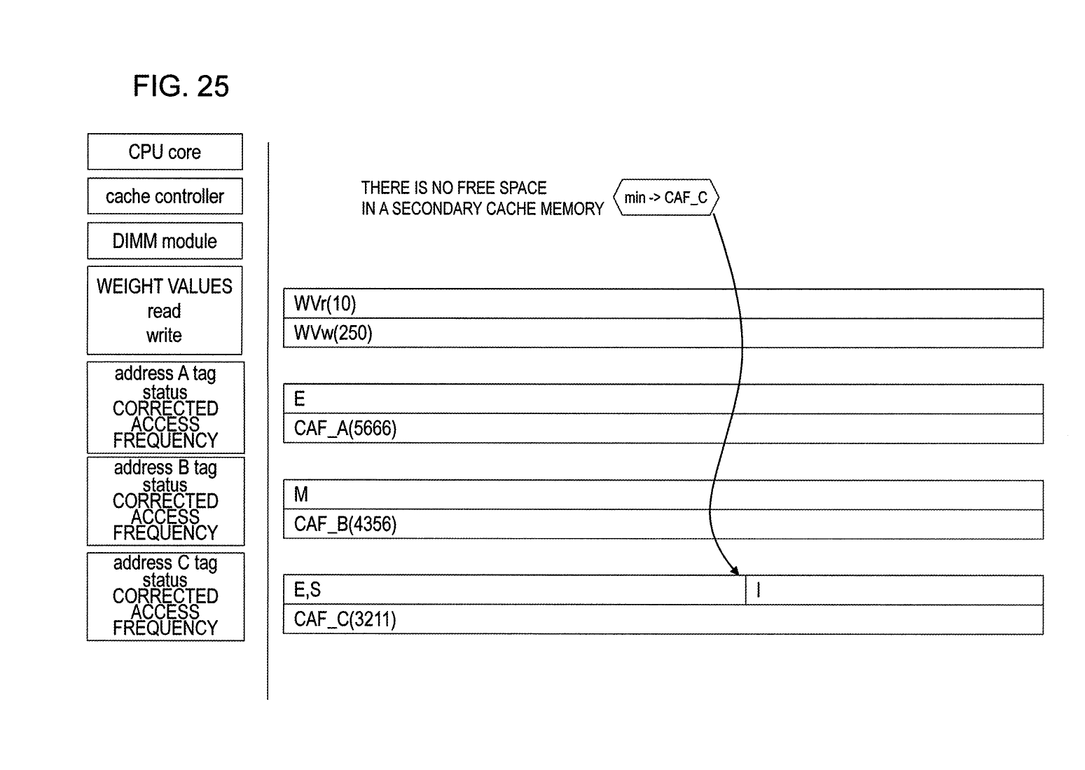

FIG. 25 is a timing chart illustrating a process of flushing a clean cache line upon a cache miss. When there is no free space in a secondary cache memory upon a cache miss, the cache control unit flushes a cache line (address C) with a lowest corrected access frequency CAF_C among the corrected access frequencies CAF of cache lines at addresses A, B, and C. At this point, status information of the cache line at address C in FIG. 25 is the E or S state and represents a clean state (state other than the M state) where no change has been made to the data in the main memory. Therefore, the memory control unit changes the status information of the tag of the cache line at address C to the I state (Invalid) and releases the cache line. Data in the cache line is discarded without being written back to the main memory.

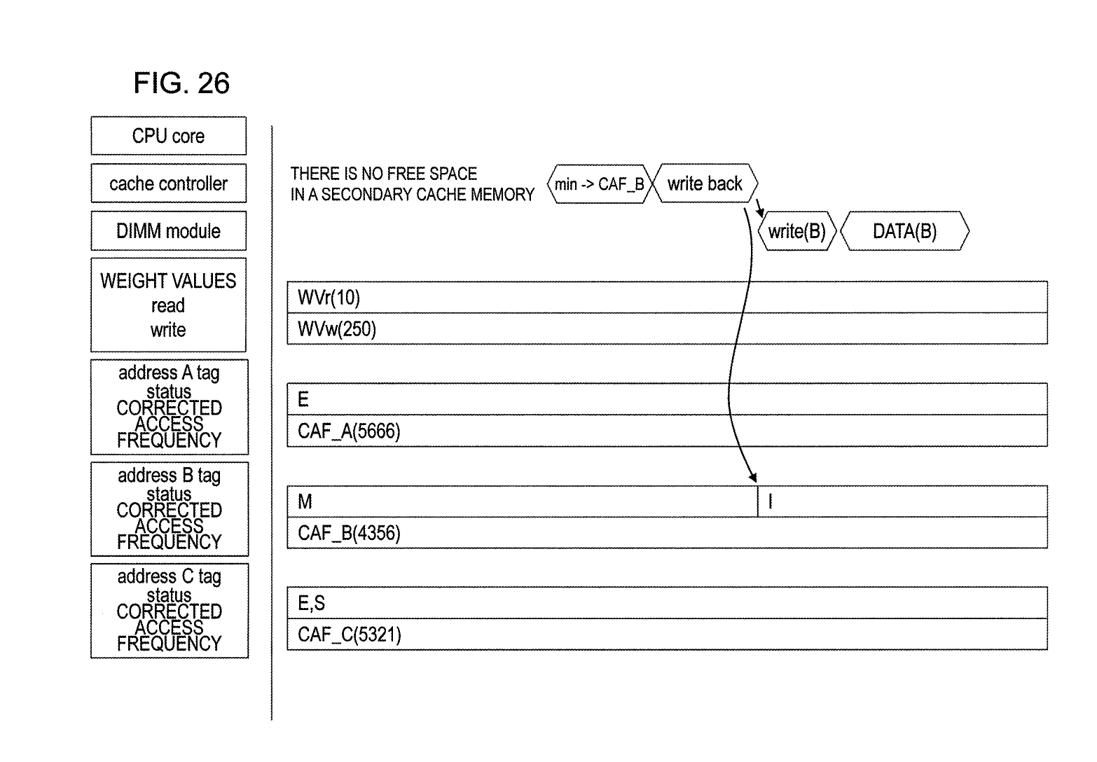

FIG. 26 is a timing chart illustrating a process of flushing a dirty cache line upon a cache miss. When there is no free space in a secondary cache memory upon a cache miss, the cache control unit flushes a cache line (address B) with a lowest corrected access frequency CAF_B among the corrected access frequencies CAF of cache lines at addresses A, B, and C. At this point, status information of the cache line at address B in FIG. 26 is the M state and represents a dirty state where a change has been made to the data in the main memory. Therefore, the memory control unit changes the status information of the tag of the cache line at address B to the I state (Invalid), releases the cache line, and issues a write back. In response thereto, a write back is performed in which data in the cache memory is written back with respect to address B in the main memory.

As described above, according to the present embodiment, processing efficiency of a processing device can be improved by minimizing access time to a main memory which is a penalty incurred upon a cache miss.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processing device capable of accessing a main memory device, comprising:
a processing unit that executes a memory access instruction;
a cache memory that retains a part of data stored by the main memory device; and
a cache control unit that controls the cache memory in response to the memory access instruction, wherein
the cache control unit includes:
a cache hit determining unit that determines a cache hit or a cache miss at the cache memory unit, based on a memory access instruction executed by the processing unit;
a read counting unit that, when the memory access instruction executed by the processing unit is a read instruction, increments a count value of read instructions;
a write counting unit that, when the memory access instruction executed by the processing unit is a write instruction, increments a count value of write instructions;
a replacement criteria generating unit that, based on the count value of read instructions counted by the read counting unit and the count value of write instructions counted by the write counting unit, generates a target read area capacity and a target write area capacity which minimize an average memory access time needed to access the main memory device in response to a cache miss determined by the cache miss determining unit; and
a replacement control unit that controls replacement of an area in the cache memory, based on the target read area capacity and the target write area capacity, when the cache miss occurs.

2. The processing device according to claim 1, wherein
the replacement criteria generating unit
calculates a read probability that represents an occurrence probability of read instructions among the memory access instructions, based on the count value of read instructions counted by the read counting unit, calculates a write probability that represents an occurrence probability of write instructions among the memory access instructions, based on the count value of write instructions counted by the write counting unit, and generates a target read area capacity and a target write area capacity which minimize an average memory access time needed to access the main memory device in response to a cache miss determined by the cache hit determining unit, based on a read time of the main memory device, a write time of the main memory device, the read probability, and the write probability.

3. The processing device according to claim 1, wherein
the replacement criteria generating unit generates a read weight value and a write weight value, based on the target read area capacity, the target write area capacity, a read probability based on the count value of read instructions, and a write probability based on the count value of write instructions,
the cache control unit adds, every time a cache hit occurs, the read weight value or the write weight value in accordance with a type of instruction to a corrected access frequency of a cache line where the cache hit has occurred, and
the replacement control unit selects a cache line with a lowest corrected access frequency as a replacement target when a cache miss occurs.

4. The processing device according to claim 1, wherein
the replacement criteria generating unit generates a read weight value and a write weight value, based on the target read area capacity, the target write area capacity, a read probability based on the count value of read instructions, and a write probability based on the count value of write instructions,
the cache control unit records, every time a cache hit occurs, an access time in a cache line where the cache hit has occurred, and
the replacement control unit selects a cache line with a longest corrected time difference, which is obtained by dividing a time difference between the access time and a cache miss time by the read weight value or the write weight value, as a replacement target when a cache miss occurs.

5. The processing device according to claim 3, wherein the replacement criteria generating unit generates the read weight value by dividing the target read area capacity by the read probability and generates the write weight value by dividing the target write area capacity by the write probability.

6. The processing device according to claim 4, wherein the replacement criteria generating unit generates the read weight value by dividing the target read area capacity by the read probability and generates the write weight value by dividing the target write area capacity by the write probability.

7. The processing device according to claim 2, wherein
the replacement criteria generating unit generates the target read area capacity and the target write area capacity, based on respective cache miss probabilities of a target read area and a target write area in the cache memory, and
the cache miss probabilities are calculated based on a capacity of a working set area in the main memory device and on the target read area capacity and the target write area capacity in the cache memory.

8. The processing device according to claim 3, wherein when replacing the cache line, the replacement control unit initializes the corrected access frequency of a new cache line to zero.

9. The processing device according to claim 3, wherein
the cache control unit resets the read probability, the write probability, and the cache miss probability when the processing unit resets a process that is a processing target, and
the replacement criteria generating unit regenerates the target read area capacity, the target write area capacity, the read weight value, and the write weight value at a shorter frequency than a processing period of the process.

10. The processing device according to claim 4, wherein
the cache control unit resets the read probability, the write probability, and the cache miss probability when the processing unit resets a process that is a processing target, and
the replacement criteria generating unit regenerates the target read area capacity, the target write area capacity, the read weight value, and the write weight value at a shorter frequency than a processing period of the process.

11. The processing device according to claim 2, wherein the replacement criteria generating unit generates the average memory access time by multiplying the read probability, the read time, and the cache miss probability of read instructions, multiplying the write probability, the write time, and the cache miss probability of write instructions, and adding up products that are multiplied.

12. The processing device according to claim 3, wherein
the cache memory includes a cache tag memory and a cache data memory, and
each cache line of the cache tag memory stores respective corrected access frequencies.

13. The processing device according to claim 1, wherein a read time of the main memory device differs from a write time of the main memory device.

14. The processing device according to claim 13, wherein the write time of the main memory device is longer than the read time of the main memory device.

15. A method of controlling a processing device which includes a processing unit that executes a memory access instruction, a cache memory, and a cache control unit that controls the cache memory in response to the memory access instruction, and is capable of accessing a main memory device, the method comprising:
a cache hit determining unit of the cache control unit determining a cache hit or a cache miss at the cache memory unit, based on a memory access instruction executed by the processing unit;
a read counting unit of the cache control unit, when the memory access instruction executed by the processing unit is a read instruction, incrementing a count value of read instructions;
a write counting unit of the cache control unit, when the memory access instruction executed by the processing unit is a write instruction, incrementing a count value of write instructions;
a replacement criteria generating unit of the cache control unit, based on the count value of read instructions counted by the read counting unit and the count value of write instructions counted by the write counting unit, generating a target read area capacity and a target write area capacity which minimize an average memory access time needed to access the main memory device in response to a cache miss determined by the cache miss determining unit; and
a replacement control unit of the cache control unit controlling replacement of an area in the cache memory, based on the target read area capacity and the target write area capacity, when the cache miss occurs.

16. The method according to claim 15, wherein
the replacement criteria generating unit
calculating a read probability that represents an occurrence probability of read instructions among the memory access instructions, based on the count value of read instructions counted by the read counting unit,
calculating a write probability that represents an occurrence probability of write instructions among the memory access instructions, based on the count value of write instructions counted by the write counting unit, and
generating a target read area capacity and a target write area capacity which minimize an average memory access time needed to access the main memory device in response to a cache miss determined by the cache hit determining unit, based on a read time of the main memory device, a write time of the main memory device, the read probability, and the write probability.

17. The method according to claim 15, wherein
the replacement criteria generating unit generating a read weight value and a write weight value, based on the target read area capacity, the target write area capacity, a read probability based on the count value of read instructions, and a write probability based on the count value of write instructions,
the cache control unit adding, every time a cache hit occurs, the read weight value or the write weight value in accordance with a type of instruction to a corrected access frequency of a cache line where the cache hit has occurred, and
the replacement control unit selecting a cache line with a lowest corrected access frequency as a replacement target when a cache miss occurs.
